(19) United States
(12) Patent Application Publication
(10) Pub. No.: US 2025/0110364 A1
(43) Pub. Date: Apr. 3, 2025

(54) DISPLAY DEVICE

(71) Applicant: Japan Display Inc., Tokyo (JP)

(72) Inventors: Kentaro OKUYAMA, TOKYO (JP); Kojiro IKEDA, TOKYO (JP); Tenfu NAKAMURA, TOKYO (JP); Chiharu KABURAGI, TOKYO (JP)

(73) Assignee: Japan Display Inc., Tokyo (JP)

(21) Appl. No.: 18/898,811

(22) Filed: Sep. 27, 2024

(30) Foreign Application Priority Data
Sep. 29, 2023 (JP) 2023-170050

(51) Int. Cl. G02F 1/1335; G02F 1/13357; G02F 1/1343

(52) U.S. Cl. CPC G02F 1/133502; G02F 1/133615; G02F 1/134318; G02F 1/13439

(57) ABSTRACT

According to one embodiment, a display device includes a display panel. A second substrate of the display panel includes a transparent first basement, a transparent conductive layer, a metal line, and a first optical layer. The transparent conductive layer is located between a first main surface of the first basement and a liquid crystal layer of the display panel. The metal line is located between the first main surface and the transparent conductive layer and is in contact with the transparent conductive layer. The first optical layer is located between the first main surface and the transparent conductive layer, made to overlap with the metal line, and has a refractive index lower than a refractive index of the first basement.

### CROSS-REFERENCE TO RELATED APPLICATIONS

This application is based upon and claims the benefit of priority from Japanese Patent Application No. 2023-170050, filed Sep. 29, 2023, the entire contents of which are incorporated herein by reference.

### FIELD

Embodiments described herein relate generally to a display device.

### BACKGROUND

Recently, display devices comprising a polymer dispersed liquid crystal (hereinafter referred to as “PDLC”) panel capable of switching a diffusing state of diffusing incident light and a transmitting state of allowing the incident light to be transmitted, displaying an image, and allowing a background to be transmitted and the image to be visually recognized, have been proposed. In such a display device, one frame period includes sub-frame periods, and multi-color display is implemented by displaying the image while changing a display color in each of the sub-frame period.

### BRIEF DESCRIPTION OF THE DRAWINGS

FIG. 1 is a plan view showing a configuration example of a display device of a first embodiment.

FIG. 2 is a developed cross-sectional view showing the display device shown in FIG. 1.

FIG. 3 is a diagram showing main constituent elements of the display device shown in FIG. 1.

FIG. 4A is a diagram showing a part of a display panel of the display device, schematically showing a liquid crystal layer in a transparent state.

FIG. 4B is a diagram showing a part of the display panel, schematically showing the liquid crystal layer in a scattered state.

FIG. 5A is a developed cross-sectional view showing the display panel in a case where when the liquid crystal layer is in a transparent state and a transparent substrate, together with a light emitting element.

FIG. 5B is a developed cross-sectional view showing the display panel in a case where when the liquid crystal layer is in a scattered state and the transparent substrate, together with a light emitting element.

FIG. 6 is a graph showing scattering characteristic of the liquid crystal layer.

FIG. 7A is a diagram showing an outline of one-line inversion drive.

FIG. 7B is a diagram showing an outline of two-line inversion drive.

FIG. 7C is a diagram showing an outline of frame-inversion drive.

FIG. 8 is a chart showing an example of a common voltage and a source line voltage in a display drive.

FIG. 9 is a chart showing an example of a common voltage and a source line voltage in a transparent drive.

FIG. 10 is a chart showing another example of the common voltage and the source line voltage in the transparent drive.

FIG. 11 is a diagram showing a configuration example of a timing controller shown in FIG. 3.

FIG. 12 is an exploded perspective view showing the display panel and the cover panel of the display device, illustrating a state in which the display panel is to be adhered to the cover panel.

FIG. 13 is a cross-sectional view showing the display device.

FIG. 14 is a developed cross-sectional view showing the display device, showing a plurality of metal lines, a plurality of optical layers, and the like.

FIG. 15 is an expanded cross-sectional view showing a part of the display panel, showing a plurality of metal lines, a plurality of optical layers, and the like.

FIG. 16 is an expanded plan view showing a part of the display panel, showing a plurality of metal lines, a plurality of optical layers, and the like.

FIG. 17 is an expanded plan view showing a part of the display panel of modified example 1 of the first embodiment, showing a plurality of metal lines, a plurality of optical layers, and the like.

FIG. 18 is an expanded cross-sectional view showing a part of a display panel of a display device of a second embodiment, showing a plurality of metal lines, a plurality of optical layers, and the like.

FIG. 19 is an expanded plan view showing a part of the display panel of the second embodiment, showing a plurality of metal lines, a plurality of optical layers, and the like.

FIG. 20 is a plan view showing a display panel and first light source units of a third embodiment.

FIG. 21 is an expanded plan view showing a first pixel of a plurality of pixels on a display panel of the third embodiment.

FIG. 22 is an expanded plan view showing a second pixel of a plurality of pixels on a display panel of the third embodiment.

FIG. 23 is an expanded plan view showing a third pixel of a plurality of pixels on a display panel of the third embodiment.

FIG. 24 is an expanded plan view showing a fourth pixel of a plurality of pixels on a display panel of the third embodiment.

FIG. 25 is an expanded plan view showing a second pixel on the display panel of modified example 1 of the third embodiment.

FIG. 26 is an expanded plan view showing a third pixel on the display panel of modified example 1 of the third embodiment.

FIG. 27 is an expanded plan view showing a second pixel on the display panel of modified example 2 of the third embodiment.

FIG. 28 is an expanded plan view showing a third pixel on the display panel of modified example 2 of the third embodiment.

FIG. 29 is an expanded plan view showing a second pixel on the display panel of modified example 3 of the third embodiment.

FIG. 30 is an expanded plan view showing a third pixel on the display panel of modified example 3 of the third embodiment.

FIG. 31 is a cross-sectional view showing the display device of modified example 4 of the third embodiment, showing a plurality of metal lines, a plurality of optical layers, and the like.

FIG. 32 is a plan view showing a display panel, first light source units, and second light source units of modified example 4.

FIG. 33 is an expanded plan view showing a sixth pixel on the display panel of modified example 4.

FIG. 34 is an expanded plan view showing a seventh pixel on the display panel of modified example 4.

FIG. 35 is a cross-sectional view showing a display device of a fourth embodiment, showing a plurality of metal lines, a plurality of optical layers, and the like.

### DETAILED DESCRIPTION

In general, according to one embodiment, there is provided a display device comprising: a display panel including a first substrate, a second substrate, and a liquid crystal layer located between the first substrate and the second substrate and containing streaky polymers and liquid crystal molecules.

The second substrate includes: a transparent first basement having a first main surface opposed to the liquid crystal layer, a second main surface on a side opposite to the first main surface, and a first side surface located between the first main surface and the second main surface; a transparent conductive layer located between the first main surface and the liquid crystal layer; a metal line located between the first main surface and the transparent conductive layer, formed of metal, and being in contact with the transparent conductive layer; and a first optical layer located between the first main surface and the transparent conductive layer, made to overlap with the metal line, and having a refractive index lower than a refractive index of the first basement.

According to another embodiment, there is provided a display device comprising: a display panel including a first substrate, a second substrate, and a liquid crystal layer located between the first substrate and the second substrate.

The second substrate includes: a transparent first basement having a first main surface opposed to the liquid crystal layer, a second main surface on a side opposite to the first main surface, and a first side surface located between the first main surface and the second main surface; a transparent conductive layer located between the first main surface and the liquid crystal layer; a metal line located between the first main surface and the transparent conductive layer, formed of metal, and being in contact with the transparent conductive layer; and a first optical layer located between the first main surface and the transparent conductive layer, made to overlap with the metal line, and having a refractive index lower than a refractive index of the first basement.

A side of the first substrate opposite to the liquid crystal layer is visually recognizable through the display panel from the second main surface.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented, but such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

In each of the embodiments, a display device employing polymer dispersed liquid crystal will be described as an example of the display device.

### First Embodiment

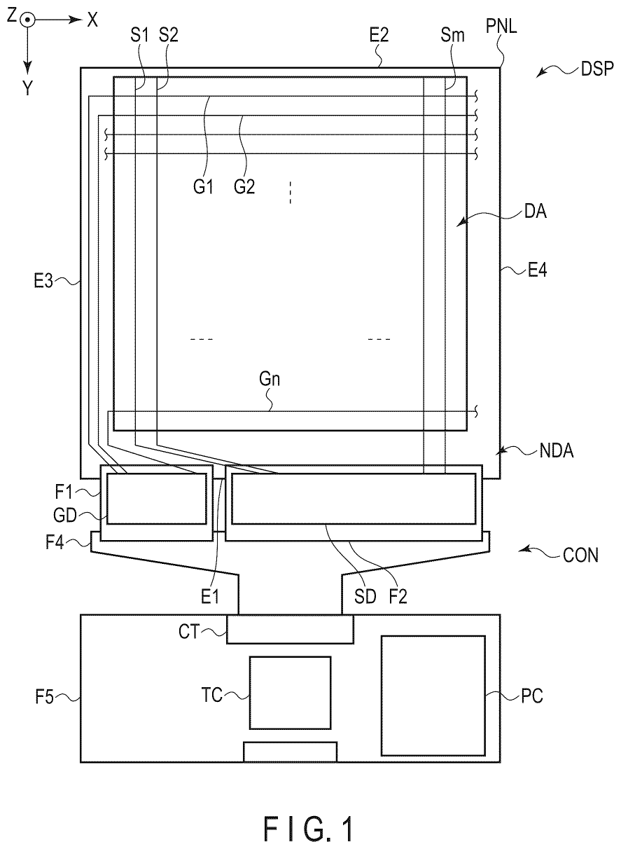

FIG. 1 is a plan view showing a configuration example of a display device DSP according to the present embodiment.

As shown in FIG. 1, a first direction X and a second direction Y are directions intersecting each other, and a third direction Z is a direction intersecting the first direction X and the second direction Y. The first direction X corresponds to the row direction while the second direction Y corresponds to the columnar direction. In one example, the first direction X, the second direction Y, and the third direction Z are orthogonal to one another but may intersect at an angle other than 90 degrees. In the present specification, a direction forwarding a tip of an arrow indicating the third direction Z is called an upward direction (or, more simply, upwardly) and a direction forwarding oppositely from the tip of the arrow is called a downward direction (or, more simply, downwardly).

The display device DSP comprises the display panel PNL, wiring boards F1, F2, F4, and F5, and the like. The display panel PNL includes the display area DA where images are displayed, and a frame-shaped non-display area NDA surrounding the display area DA. The display area DA includes n gate lines G (G1 to Gn), m source lines S (S1 to Sm), and the like. Incidentally, each of n and m is a positive integer, and n may be equal to or different from m. The plurality of gate lines G extend in the first direction X and are arranged to be spaced apart in the second direction Y. In other words, the plurality of gate lines G extend in the row direction. The plurality of source lines S extend in the second direction Y and are arranged to be spaced apart in the first direction X. The display panel PNL includes end portions E1 and E2 along the first direction X and end portions E3 and E4 along the second direction Y.

The wiring board F1 includes a gate driver GD. The plurality of gate lines G are connected to the gate driver GD. The wiring board F2 includes a source driver SD. The plurality of source lines S are connected to the source driver SD. Each of the wiring boards F1 and F2 is connected to the display panel PNL and the wiring board F4. The wiring board F5 includes a timing controller TC, a power supply circuit PC, and the like. The wiring board F4 is connected to a connector CT of the wiring board F5. Incidentally, the wiring boards F1 and F2 may be replaced with a single wiring board. Alternatively, the wiring boards F1, F2, and F4 may be replaced with a single wiring board. The gate driver GD, the source driver SD, and the timing controller TC described above constitute the control unit CON of the present embodiment, and the control unit CON is configured to control the drive of each of the plurality of gate lines G, the plurality of source lines S, a plurality of pixel electrodes to be described later, a common electrode to be described later, and the light source unit to be described later.

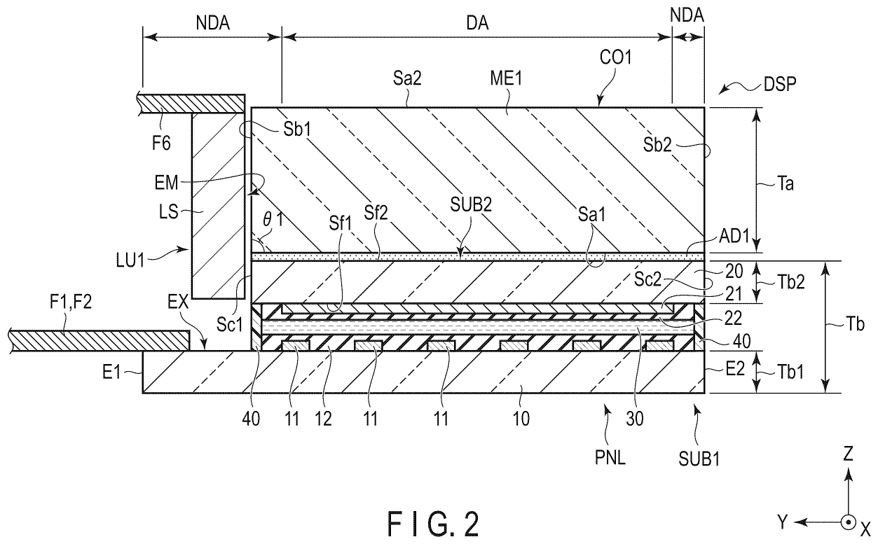

FIG. 2 is a developed cross-sectional view showing the display device DSP shown in FIG. 1. Several portions in the cross-section of the display device DSP on a Y-Z plane defined by the second direction Y and the third direction Z will be described here. An optical layer, a metal line and the like to be described below are not shown in FIG. 2.

As shown in FIG. 2, the display device DSP comprises a cover panel CO1. The cover panel CO1 comprises a transparent substrate ME1. The transparent substrate ME1 is a cover glass and is formed of glass. The transparent substrate ME1 is a non-flexible substrate. The transparent substrate ME1 overlaps with at least the entire display area DA.

The transparent substrate ME1 has a main surface Sa1, a main surface Sa2, a side surface Sb1, and a side surface Sb2. The main surface Sa1 functions as a seventh main surface, the main surface Sa2 functions as an eighth main surface, and the side surface Sb1 functions as a third side surface. The main surface Sa2 is located on a side opposite to the main surface Sa1. The side surface Sb1 is located between the main surface Sa1 and the main surface Sa2. The side surface Sb1 is a first light incident surface. The side surface Sb2 is located between the main surface Sa1 and the main surface Sa2 and is located on a side opposite to the side surface Sb1. In the present embodiment, the side surface Sb1 and the side surface Sb2 are located in the non-display area NDA. An angle between the main surface Sa1 and the side surface Sb1 is referred to as θ1. In the present embodiment, the angle θ1 is 90 degrees.

The display panel PNL has a display area DA where images are displayed and external light is transmitted. The display panel PNL is opposed to the main surface Sa1 of the transparent substrate ME1. The display panel PNL has flexibility. The display panel PNL comprises a first substrate SUB1, a second substrate SUB2, a liquid crystal layer 30 serving as a display function layer, and the like. The first substrate SUB1 comprises a transparent basement 10, a pixel electrode 11, an alignment film 12, and the like. The pixel electrodes 11 is located between the basement 10 and the liquid crystal layer 30. The second substrate SUB2 comprises a transparent basement 20, a common electrode 21, an alignment film 22, and the like. The basement 20 functions as a first basement while the basement 10 functions as a second basement.

The basement 20 has a main surface Sf1, a main surface Sf2, a side surface Sc1, and a side surface Sc2. The main surface Sf1 is opposed to the liquid crystal layer 30. The side surface Sc1 is located between the main surface Sf1 and the main surface Sf2. The side surface Sc2 is located between the main surface Sf1 and the main surface Sf2. In the basement 20, the side surface Sc2 is located on the side opposite to the side surface Sc1. The main surface Sf1 functions as a first main surface, the main surface Sf2 functions as a second main surface, and the side surface Sc1 functions as a first side surface.

The basement 20 is located between the basement 10 and the transparent substrate ME1. The pixel electrodes 11 and the common electrode 21 are formed of, for example, a transparent conductive material such as indium tin oxide (ITO) or indium zinc oxide (IZO). The liquid crystal layer 30 is located in at least the display area DA.

The liquid crystal layer 30 is located between the basement 10 (first substrate SUB1) and the basement 20 (second substrate SUB2). More specifically, the liquid crystal layer 30 is located between the alignment films 12 and 22. The liquid crystal layer 30 contains polymer dispersed liquid crystal. The liquid crystal layer 30 of the present embodiment uses reverse mode polymer dispersed liquid crystal (R-PDLC). The above-described liquid crystal layer 30 maintains the parallelism of light made incident when the applied voltage is low or scatters the incident light when the applied voltage is high. The first substrate SUB1 and the second substrate SUB2 are bonded to each other by a sealing material 40. The first substrate SUB1 includes an extending portion EX that extends farther in the second direction Y than the side surface Sc1 of the basement 20.

An adhesive sheet AD1 is located between the transparent substrate ME1 and the display panel PNL and adheres the display panel PNL to the transparent substrate ME1. The adhesive sheet AD1 is in contact with and sticks to the transparent substrate ME1 on one side and is in contact with and sticks to the display panel PNL on the other side. The adhesive sheet AD1 overlaps with at least the entire display area DA. The adhesive sheet AD1 is formed of an optical clear adhesive (OCA) as a solid adhesive. However, the adhesive sheet AD1 may be formed of a material other than OCA, for example, optically clear resin (OCR). Furthermore, the display panel PNL and the transparent substrate ME1 may be adhered. In other words, the present embodiment includes a structure in which the display panel PNL and the transparent substrate ME1 are fixed. Therefore, the adhesive sheet AD1 is also referred to as a fixing member. In addition, no air layer is desirably located between the display panel PNL and the transparent substrate ME1.

The wiring boards F1 and F2 are connected to the extending portion EX of the first substrate SUB1.

A first light source unit LU1 is located in the non-display area NDA outside the display area DA. The first light source unit LU1 comprises a light emitting element LS, a wiring board F6, and the like. The light emitting element LS is connected to the wiring board F6 and located on the extending portion EX. The light emitting element LS is located on the side surface Sc1 (side surface Sb1) side with respect to the display area DA in the second direction Y, and can emit light toward the display area DA. The light emitting element LS includes a light emitting portion (light emitting surface) EM that is opposed to the side surface Sb1 to emit light to the side surface Sb1.

The illumination light emitted from the light emitting portion EM is made incident on the side surface Sb1 and propagates through the transparent substrate ME1 (cover panel CO1), the adhesive sheet AD1, and the display panel PNL, as described below. In the present embodiment, the light emitting portion EM is also opposed to the side surface Sc1 of the basement 20 and further emits light to the side surface Sc1.

Each of the basement 10 and the basement 20 is formed of glass. The basement 10 has a thickness Tb1 and the basement 20 has a thickness Tb2. Each of the thickness Tb1 and the thickness Tb2 is 0.2 mm or less. More specifically, each of the thickness Tb1 and the thickness Tb2 is 0.1 to 0.2 mm. In the present embodiment, each of the thickness Tb1 and the thickness Tb2 is 0.15 mm. The display panel PNL can be made flexible by forming the basement 10 and the basement 20 to be thin.

The transparent substrate ME1 has a thickness Ta and the display panel PNL has a thickness Tb, in the direction in which the transparent substrate ME1 and the display panel PNL are opposed. The thickness Tb includes the thickness Tb1, the thickness Tb2, the thickness of the liquid crystal layer 30, and the like. The thickness Ta of the transparent substrate ME1 is desirably larger than the thickness Tb of the display panel PNL. In the present embodiment, the thickness Ta of the transparent substrate ME1 is larger than the thickness Tb of the display panel PNL. The thickness Ta is 0.7 to 3.0 mm.

As described above, even if the thickness Tb2 of the basement 20 is reduced, the transparent substrate ME1 has a thickness Ta larger than the thickness Tb2. The first light source unit LU1 can emit light to the side surface Sb1 of the transparent substrate ME1. For this reason, the user can visually recognize the display images of the display device DSP desirably as compared to the case where the light source unit LU1 emits light to the side surface Sc1 of the basement 20. For example, the contrast ratio of the display device DSP can be increased.

In the present embodiment, the first light source unit LU1 emits light not only to the side surface Sb1 but also to the side surface Sc1. Therefore, the user can visually recognize the display images of the display device DSP further desirably.

Unlike the present embodiment, however, the light emitting element LS may be opposed to the only side surface Sb1 and emit light to the only side surface Sb1.

Incidentally, the transparent substrate ME1 and the display panel PNL of the present embodiment are curved. However, the transparent substrate ME1 and the display panel PNL may not be curved. In this case, the main surface Sa1, the main surface Sf1, and the like may be parallel to the X-Y plane as shown in FIG. 2.

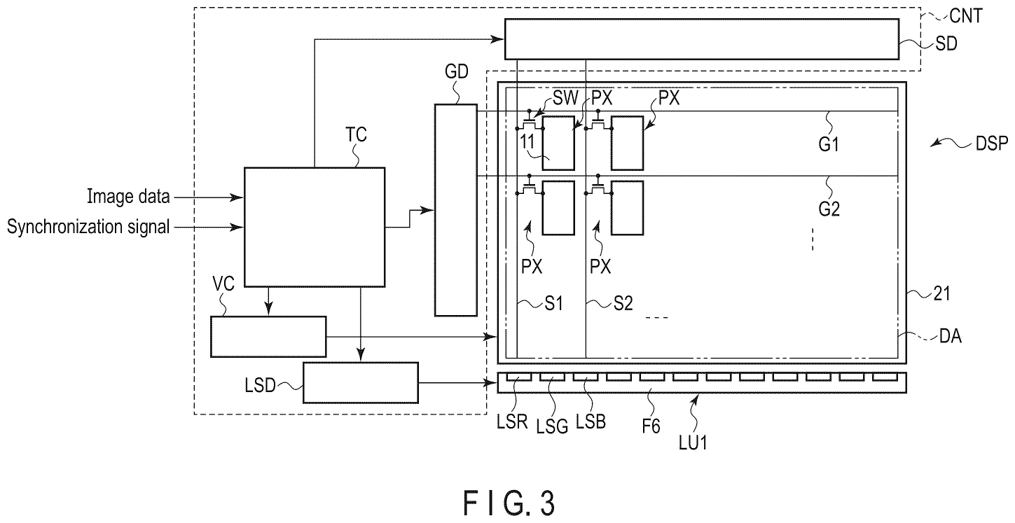

FIG. 3 is a diagram showing main constituent elements of the display device DSP shown in FIG. 1.

As shown in FIG. 3, the display device DSP comprises a controller CNT represented by a broken line in the drawing. The controller CNT includes a timing controller TC, a gate driver GD, a source driver SD, a Vcom circuit VC, a light source driver LSD, and the like.

The timing controller TC generates various signals, based on image data, a synchronization signal, and the like input from the outside. In one example, the timing controller TC outputs video signals generated by executing predetermined signal processing, based on the image data, to the source driver SD. In addition, the timing controller TC outputs the control signal generated based on the synchronization signals to each of the gate driver GD, the source driver SD, the Vcom circuit VC, and the light source driver LSD. The timing controller TC will be described below in detail.

A plurality of pixels PX are provided in the display area DA represented by a two-dot chain line in the drawing. Each of the pixels PX comprises a switching element SW and the pixel electrode 11. The switching element SW is formed of, for example, a thin-film transistor. The switching element SW is electrically connected to the gate line G and the source line S. The plurality of pixel electrodes 11 are located in the display area DA and arrayed in a matrix. For this reason, for example, the plurality of pixel electrodes 11 are provided in a plurality of rows. The pixel electrode 11 is connected to the source line S via the switching element SW. The common electrode 21 is located in the display area DA. The common electrode 21 is opposed to the plurality of pixel electrodes 11. Unlike the present embodiment, the common electrode 21 may be divided for each of at least one pixel PX and connected to each common line, and a common voltage may be applied to the divided common electrodes.

A gate signal is supplied from the gate driver GD to each of the gate lines G. The video signal (image signal) is supplied from the source driver SD to each of the source lines S. A common voltage Vcom is supplied from the Vcom circuit VC to the common electrode 21. The video signal supplied to the source line S is applied to the pixel electrode 11 connected to the switching element SW in a period in which the switching element SW becomes a conductive state based on the gate signal supplied to the gate line G. In the following descriptions, supplying the video signal to the pixel electrode 11 to form a potential difference between the pixel electrode 11 and the common electrode 21 may be referred to as writing the video signal (or applying the voltage) to the pixel PX comprising the pixel electrode 11.

The first light source unit LU1 is configured to emit light to the liquid crystal layer 30. In the present embodiment, the first light source unit LU1 is configured to emit light of a color other than achromatic color to the liquid crystal layer 30. The first light source unit LU1 comprises light emitting elements LS of a plurality of colors. For example, the first light source unit LU1 comprises a light emitting element (first light emitting element) LSR which emits light of a first color to the liquid crystal layer 30, a light emitting element (second light emitting element) LSG which emits light of a second color to the liquid crystal layer 30, and a light emitting element (third light emitting element) LSB which emits light of a third color to the liquid crystal layer 30. It is needless to say that the first, second, and third colors are different from one another. In the present embodiment, the first color is red, the second color is green, and the third color is blue.

The light source driver LSD controls lighting periods of the light emitting elements LSR, LSG, and LSB. In a driving system in which a one-frame period includes a plurality of sub-frame periods, at least one of three light emitting elements LSR, LSG, and LSB is turned on in each of the sub-frames such that the color of the illumination light is changed in each sub-frame, which will be described below in detail.

A configuration example of the display device comprising the liquid crystal layer 30 which is a polymer dispersed liquid crystal layer will be described below.

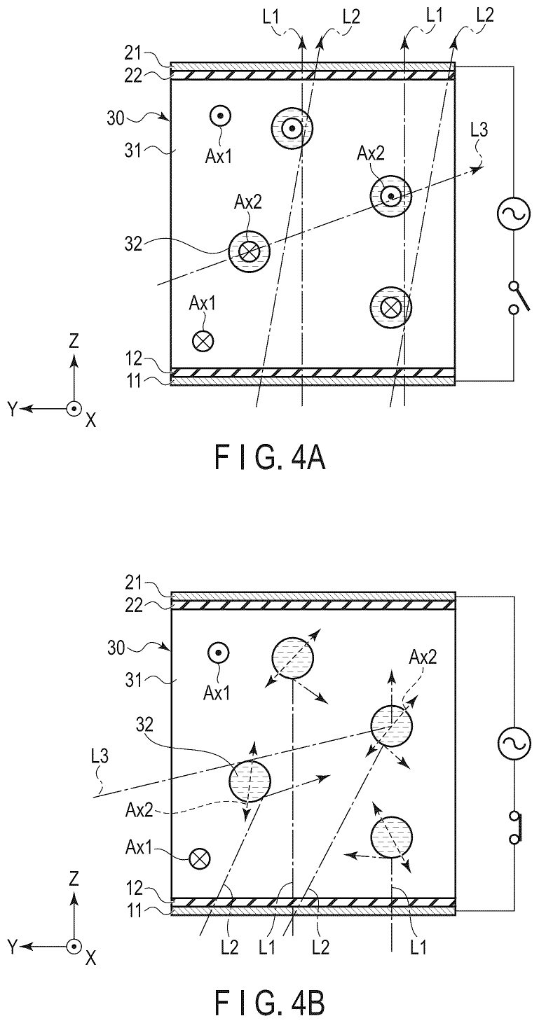

FIG. 4A is a diagram showing a part of the display panel PNL, schematically illustrating the liquid crystal layer 30 in a transparent state.

As shown in FIG. 4A, the liquid crystal layer 30 contains a liquid crystalline polymer 31 that is a streaky polymer, and liquid crystalline molecules 32. The liquid crystalline polymer 31 can be obtained by, for example, polymerizing liquid crystalline monomer in a state of being aligned in a predetermined direction by the alignment restriction force of the alignment films 12 and 22. The liquid crystalline molecules 32 are dispersed in the liquid crystalline monomer, and are aligned in a predetermined direction depending on the alignment direction of the liquid crystalline monomer when the liquid crystalline monomer is polymerized. In the present embodiment, the alignment films 12 and 22 are horizontal alignment films that initially align the liquid crystalline monomer and the liquid crystalline molecules 32 along the X-Y plane defined by the first direction X and the second direction Y. The liquid crystalline molecules 32 are positive liquid crystalline molecules having positive dielectric anisotropy.

Unlike the present embodiment, however, the alignment films 12 and 22 may be vertical alignment films that initially align the liquid crystalline monomer and the liquid crystalline molecules 32 along the third direction Z. Alternatively, the liquid crystalline molecules 32 may be negative liquid crystalline molecules having negative dielectric anisotropy.

The liquid crystalline polymer 31 and the liquid crystalline molecules 32 have equivalent optical anisotropy. Alternatively, the liquid crystalline polymer 31 and the liquid crystalline molecules 32 have substantially equal refractive anisotropy. In other words, an ordinary refractive index and an extraordinary refractive index of each of the liquid crystalline polymer 31 and the liquid crystalline molecules 32 are substantially equal to each other.

Incidentally, for both the ordinary refractive index and the extraordinary refractive index, values of the liquid crystalline polymer 31 and the liquid crystalline molecules 32 may not completely match each other, and a deviation caused by an error in manufacturing or the like is allowed. In addition, the liquid crystalline polymer 31 and the liquid crystalline molecules 32 are different in responsiveness to the electric field. In other words, the responsiveness of the liquid crystalline polymer 31 to the electric field is lower than the responsiveness of the liquid crystalline molecules 32 to the electric field.

The example illustrated in FIG. 4A corresponds to a state in which no voltage is applied to the liquid crystal layer 30 (for example, a state in which a potential difference between the pixel electrode 11 and the common electrode 21 is zero) or a state in which a second transparent voltage to be described below is applied to the liquid crystal layer 30.

As shown in FIG. 4A, an optical axis Ax1 of the liquid crystalline polymer 31 and an optical axis Ax2 of the liquid crystalline molecules 32 are parallel to each other. In the example illustrated, each of the optical axis Ax1 and the optical axis Ax2 is parallel to the first direction X. The optical axis corresponds to a line parallel to a direction of travel of the light beam in which the refractive indexes indicate one value irrespective of the direction of polarization.

As described above, since the liquid crystalline polymer 31 and the liquid crystalline molecules 32 have the approximately equal refractive anisotropy and the optical axes Ax1 and Ax2 are parallel to each other, there is almost no refractive index difference between the liquid crystalline polymer 31 and the liquid crystalline molecules 32 in all directions including the first direction X, the second direction Y, and the third direction Z. For this reason, light beams L1 made incident on the liquid crystal layer 30 in the third direction Z are not substantially scattered in the liquid crystal layer 30 but are transmitted. The liquid crystal layer 30 can maintain the parallelism of the light beams L1. Similarly, light beam L2 and light beam L3 made incident in an oblique direction angled with respect to the third direction Z are hardly scattered in the liquid crystal layer 30. For this reason, high transparency can be obtained. The state illustrated in FIG. 4A is referred to as a transparent state.

FIG. 4B is a diagram showing a part of the display panel PNL, schematically showing the liquid crystal layer 30 in a scattered state.

As shown in FIG. 4B, as described above, the responsiveness of the liquid crystalline polymer 31 to the electric field is lower than the responsiveness of the liquid crystalline molecule 32 to the electric field. For this reason, in a state in which a voltage (scattering voltage to be described later) higher than each of the second transparent voltage and a first transparent voltage to be described below is applied to the liquid crystal layer 30, the alignment direction of the liquid crystalline molecules 32 is changed in accordance with the electric field while the alignment direction of the liquid crystalline polymer 31 is hardly changed. In other words, as illustrated in the drawing, the optical axis Ax1 is substantially parallel to the first direction X while the optical axis Ax2 is oblique to the first direction X. For this reason, the optical axes Ax1 and the optical axes Ax2 intersect each other. Therefore, a large refractive index difference is made between the liquid crystalline polymer 31 and the liquid crystalline molecules 32 in all the directions including the first direction X, the second direction Y, and the third direction Z. The light beams L1 to L3 made incident on the liquid crystal layer 30 are therefore scattered in the liquid crystal layer 30. The state shown in FIG. 4B is referred to as a scattered state.

The control unit CON switches the state of the liquid crystal layer 30 to at least one of the transparent state and the scattered state.

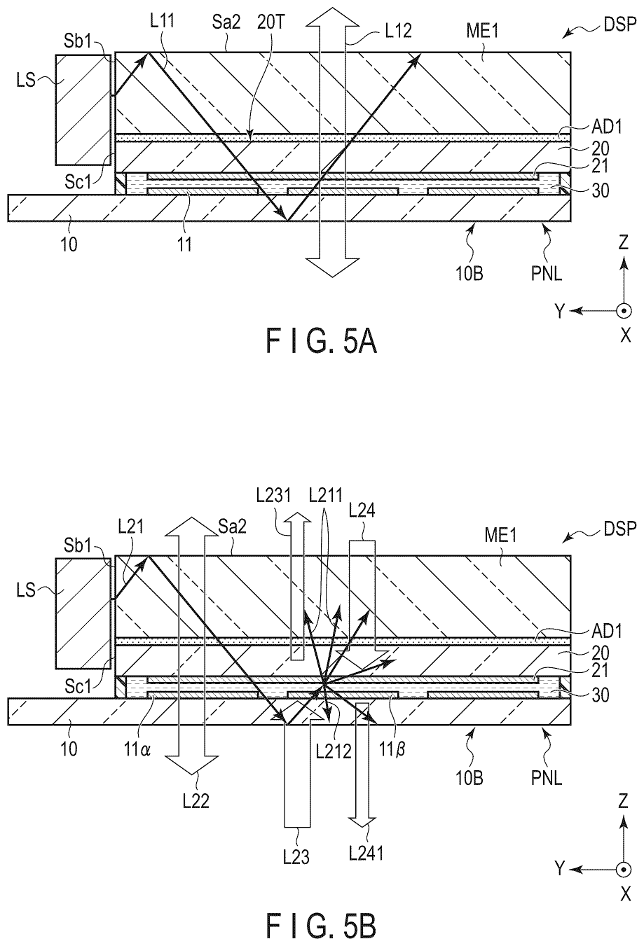

FIG. 5A is a developed cross-sectional view showing the display panel PNL in a case where the liquid crystal layer 30 is in a transparent state and the transparent substrate ME1, together with the light emitting element LS. As shown in FIG. 5A, the basement 10 has a lower surface 10B and the basement 20 has an upper surface 20T. Illumination light emitted from the light emitting element LS is made incident on the cover panel CO1 and the display panel PNL from the side surface Sb1 of the transparent substrate ME1 and the side surface Sc1 of the basement 20.

For example, illumination light L11 emitted from the light emitting element LS and made incident on the side surface Sb1 of the transparent substrate ME1 propagates through the transparent substrate ME1, the adhesive sheet AD1, the basement 20, the liquid crystal layer 30, the basement 10, and the like. When the liquid crystal layer 30 is in a transparent state, the illumination light L11 is hardly scattered in the liquid crystal layer 30 and therefore rarely leaks out from the lower surface 10B of the basement 10 and the main surface Sa2 of the transparent substrate ME1.

An external light beam L12 made incident on the display panel PNL is hardly scattered in the liquid crystal layer 30 and is transmitted. In other words, the external light made incident on the display panel PNL from the lower surface 10B is transmitted to the main surface Sa2 of the transparent substrate ME1, and the external light made incident from the main surface Sa2 is transmitted to the lower surface 10B. For this reason, when the display device DSP is observed from the main surface Sa2 side, the user can visually recognize a background on the lower surface 10B side through the display panel PNL. Similarly, when the display device DSP is observed from the lower surface 10B side, the user can visually recognize a background on the main surface Sa2 side through the display panel PNL.

FIG. 5B is a developed cross-sectional view showing the display panel PNL in a case where the liquid crystal layer 30 is in a scattered state and the transparent substrate ME1, together with the light emitting element LS. As shown in FIG. 5B, the illumination light emitted from the light emitting element LS is made incident on the cover panel CO1 and the display panel PNL from the side surface Sb1 of the transparent substrate ME1 and the side surface Sc1 of the basement 20.

For example, illumination light L21 emitted from the light emitting element LS and made incident on the side surface Sb1 of the transparent substrate ME1 propagates through the transparent substrate ME1, the adhesive sheet AD1, the basement 20, the liquid crystal layer 30, the basement 10, and the like. In the example illustrated, since the liquid crystal layer 30 between a pixel electrode 11α and the common electrode 21 (i.e., a liquid crystal layer to which a voltage applied between the pixel electrode 11α and the common electrode 21 is applied) is in a transparent state, the illumination light beam L21 is hardly scattered in an area opposed to the pixel electrode 11α, in the liquid crystal layer 30.

In contrast, since the liquid crystal layer 30 between a pixel electrode 11β and the common electrode 21 (i.e., a liquid crystal layer to which a voltage applied between the pixel electrode 11β and the common electrode 21 is applied) is in the scattered state, the illumination light beam L21 is scattered in an area opposed to the pixel electrode 11B, in the liquid crystal layer 30. A scattered light beam L211 of the illumination light beam L21 is emitted to the outside from the main surface Sa2, and a scattered light beam L212 is emitted to the outside from the lower surface 10B.

At a position which overlaps with the pixel electrode 11α, an external light beam L22 made incident on the display panel PNL is hardly scattered in the liquid crystal layer 30 and is transmitted, similarly to the external light beam L12 shown in FIG. 5A. At a position which overlaps with the pixel electrode 11β, a light beam L231 of an external light beam L23 made incident from the lower surface 10B is scattered in the liquid crystal layer 30 and then transmitted from the main surface Sa2. In addition, a light beam L241 of an external light beam L24 made incident from the main surface Sa2 is scattered in the liquid crystal layer 30 and then transmitted from the lower surface 10B.

For this reason, when the display device DSP is observed from the main surface Sa2 side, a color of the illumination light beam L21 can be visually recognized at a position which overlaps with the pixel electrode 11β. In addition, since the external light beam L231 is transmitted through the display panel PNL, the background on the lower surface 10B side can also be visually recognized through the display panel PNL. Similarly, when the display device DSP is observed from the lower surface 10B side, a color of the illumination light beam L21 can be visually recognized at a position which overlaps with the pixel electrode 11β. In addition, since the external light beam L241 is transmitted through the display panel PNL, the background on the main surface Sa2 side can also be visually recognized through the display panel PNL. At a position which overlaps with the pixel electrode 11α, the color of the illumination light beam L21 can hardly be recognized visually and the background can be visually recognized through the display panel PNL since the liquid crystal layer 30 is in the transparent state.

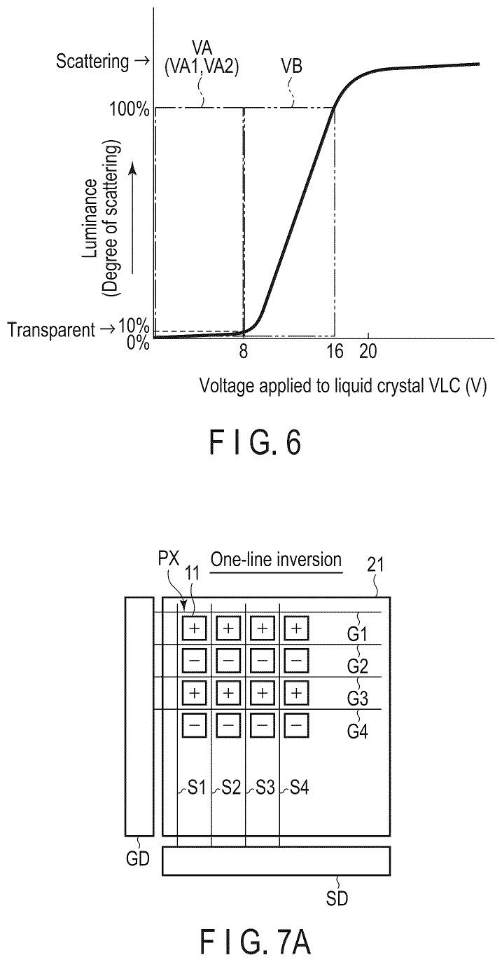

FIG. 6 is a graph showing the scattering characteristic of the liquid crystal layer 30, indicating a relationship between the luminance and a voltage VLC applied to the liquid crystal layer 30. The luminance corresponds to luminance of scattered light beam L211 obtained when the illumination light beam L21 emitted from the light emitting element LS is scattered in the liquid crystal layer 30 as shown in, for example, FIG. 5B. This luminance indicates a scattering degree of the liquid crystal layer 30 from the other viewpoint.

As shown in FIG. 6, when the voltage VLC is increased from 0V, the luminance is rapidly increased from approximately 8V and saturated at approximately 20V. Incidentally, the luminance is slightly increased if the voltage VLC is in a range from 0V to 8V. In the present embodiment, the voltage in an area surrounded by a two-dot chain line, i.e., a range from 8V to 16V is used for reproduction of gradation (for example, 256 gradation) of each pixel PX. The voltage in a range 8V<VLC≤16V is hereinafter referred to as a scattering voltage. In addition, in the present embodiment, the area surrounded by a one-dot chain line, i.e., the voltage in a range 0V≤VLC≤8V is referred to as a transparent voltage. A transparent voltage VA includes the first transparent voltage VA1 and second transparent voltage VA2 described above. Incidentally, the lower limit and the upper limit of the scattering voltage VB and the transparent voltage VA are not limited to this example but can arbitrarily be determined in accordance with the scattering property of the liquid crystal layer 30.

The degree of scattering in a case where the scattering voltage VB is applied to the liquid crystal layer 30 and the degree of scattering of the light made incident on the liquid crystal layer 30 is the highest is assumed to be 100%. The degree of scattering in a case of applying the scattering voltage VB of 16V to the liquid crystal layer 30 is assumed to be 100%. For example, the transparent voltage VA can be defined as a voltage in a range of the voltage VLC with the degree of scattering (luminance) less than 10%. Alternatively, the transparent voltage VA can also be defined as the voltage VLC lower than or equal to a voltage (8V in the example of FIG. 6) corresponding to the lowest gradation.

In addition, the transparent voltage VA (first transparent voltage VA1 and second transparent voltage VA2) may be different from that in the example shown in FIG. 6. For example, the first transparent voltage VA1 may be a voltage with the degree of scattering in a range of 10% or more and 50% or less. In addition, the second transparent voltage VA2 may be a voltage with the degree of scattering in a range lower than 10%.

Incidentally, the graph shown in FIG. 6 is applicable to a case where the polarity of the voltage applied to the liquid crystal layer 30 is positive polarity (+) and negative polarity (−). In the latter case, the voltage VLC is an absolute value of the negative-polarity voltage.

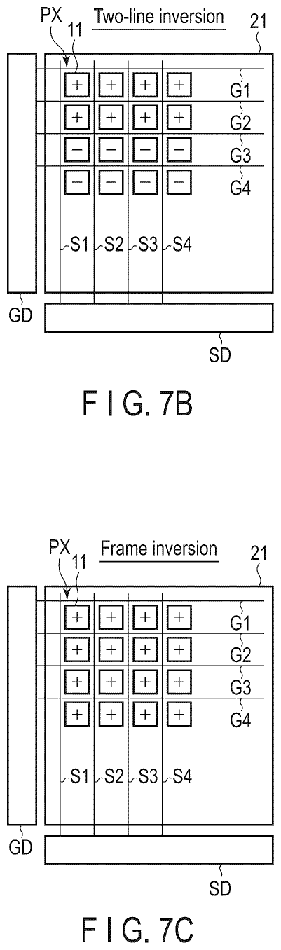

The polarity inversion drive scheme of inverting the polarity of the voltage applied to the liquid crystal layer 30 can be applied to the display device DSP. FIG. 7A, FIG. 7B, and FIG. 7C are diagrams showing an outline of the polarity inversion drive scheme.

FIG. 7A shows a one-line inversion drive scheme of inverting the positive polarity (+) and the negative polarity (−) of the voltage applied to the liquid crystal layer 30 (i.e., the voltage written to the pixel PX) in each group of pixels PX (one line) connected to one gate line G. In such a drive scheme, for example, the polarity of the common voltage supplied to the common electrode 21 and the polarity of the video signal supplied from the source driver SD to the source line S (i.e., polarity of a source line voltage) are inverted for each horizontal period in which the gate driver GD supplies the gate signal to the gate line G. In the same horizontal period, the polarity of the common voltage and the polarity of the video signal are, for example, opposite to each other.

FIG. 7B shows a two-line inversion drive scheme of inverting the positive polarity (+) and the negative polarity (−) of the voltage to be applied to the liquid crystal layer 30 in every two lines. The present invention is not limited to the example shown in FIG. 7A and FIG. 7B, but the polarity may be inverted in every three or more lines.

FIG. 7C shows a frame-inversion drive scheme of inverting the positive polarity (+) and the negative polarity (−) of the voltage applied to the liquid crystal layer 30 in each frame period for displaying an image corresponding to one piece of image data. In such a drive method, for example, the polarity of the common voltage and the polarity of the video signal are inverted in each frame period. In the same frame period, for example, the polarity of the common voltage and the polarity of the video signal are opposite to each other.

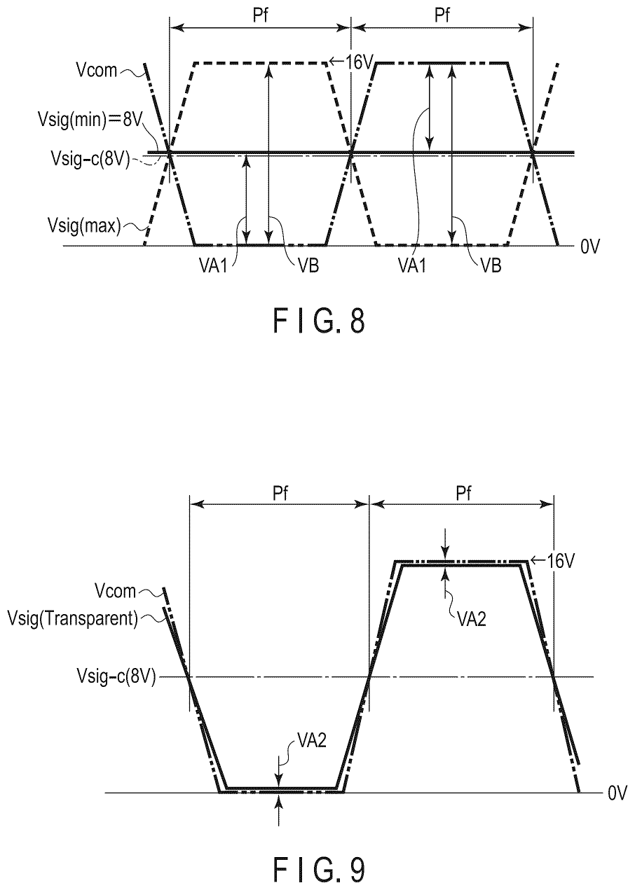

FIG. 8 is a chart showing an example of the common voltage Vcom supplied to the common electrode 21 and the source line voltage Vsig supplied to the source line S (or the pixel electrode 11) in the display drive to which the one-line inversion drive scheme shown in FIG. 7A is applied.

As shown in FIG. 8, a waveform corresponding to a maximum value (max) of gradation and a waveform corresponding to a minimum value (min) of gradation are illustrated with respect to the source line voltage Vsig. The waveform of the source line voltage Vsig (min) is represented by a solid line, the waveform of the common voltage Vcom is represented by a two-dot chain line, and the waveform of the source line voltage Vsig (max) is represented by a broken line. In the example of this drawing, the polarities of the common voltage Vcom and the source line voltage Vsig (see the waveform of the maximum value) are inverted in each frame period Pf. A reference voltage Vsig-c is, for example, 8V. The lower limit is 0V and the upper limit is 16V in each of the common voltage Vcom and the source line voltage Vsig.

However, when the frame period Pf includes a plurality of sub-frame periods, the polarity of the common voltage Vcom and the polarity of the source line voltage Vsig may be inverted in each frame period Pf, or may be inverted in each field period.

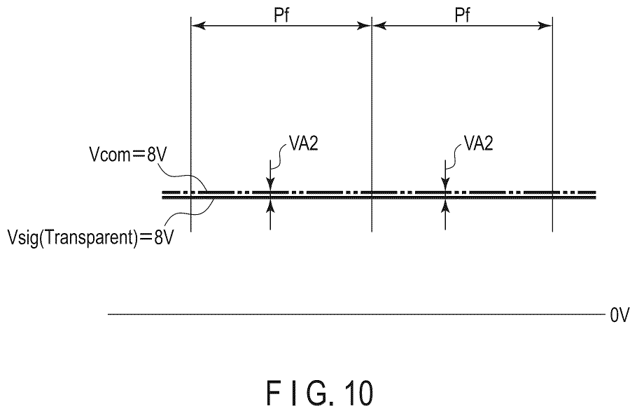

The polarity inversion drive scheme including not only the example shown in FIG. 8, but the example of FIG. 9 to be described later will be focused. When the drive voltage to be applied to the liquid crystal layer 30 (voltage to be written to the pixel PX) has a positive polarity, a difference (Vsig-Vcom) between the source line voltage Vsig and the common voltage Vcom becomes 0V or a positive voltage value. In contrast, if the drive voltage to be applied to the liquid crystal layer 30 (voltage to be written to the pixel PX) has negative polarity, the difference (Vsig-Vcom) between the source line voltage Vsig and the common voltage Vcom is 0V or a negative voltage value.

The polarity inversion drive scheme shown in FIG. 8 will be focused. In a period in which the positive-polarity voltage is written to the pixel PX, the common voltage Vcom becomes 0V, and the source line voltage Vsig becomes a voltage value corresponding to gradation indicated by image data in a range of 8V or more and 16V or less. In contrast, in a period in which the negative-polarity voltage is written to the pixel PX, the common voltage Vcom becomes 16V, and the source line voltage Vsig becomes a voltage value corresponding to gradation indicated by image data in a range of 0V or more and 8V or less. In other words, in either of the cases, the voltage of 8V or more and 16V or less is applied between the common electrode 21 and the pixel electrode 11.

As shown in FIG. 6, even when the voltage VLC applied to the liquid crystal layer 30 is 8V, i.e., the first transparent voltage VA1 is applied to the liquid crystal layer 30, the liquid crystal layer 30 has the degree of scattering of approximately 0 to 10%. Therefore, even if the source line voltage Vsig is the minimum value of the gradation, the external light beam made incident on the display panel PNL may be slightly scattered and the visibility of the background of the display panel PNL may be lowered.

For this reason, the visibility of the background of the display panel PNL can be improved by applying the transparent drive of making the voltage between the pixel electrode 11 and the common electrode 21 smaller than the lower limit of gradation to the sequence of image display.

A relationship between the common voltage Vcom and the output of the source driver SD will be described here.

When a withstand voltage of the source driver SD is low, the common voltage Vcom is inversely driven to increase the liquid crystal applied voltage. At this time, the source driver SD can simultaneously output only one of the positive-polarity source line voltage Vsig (for example, reference voltage Vsig-c to 16V) and the negative-polarity source line voltage Vsig (for example, 0V to reference voltage Vsig-c). In addition, the polarity of the common voltage Vcom is opposite to the polarity of the output of the source driver SD.

However, when the source driver SD of a high withstand voltage is used, the relationship between the source line voltage Vsig and the common voltage Vcom may be the same as the above-described relationship but may also be a relationship to be described below. In other words, the common voltage Vcom is fixed to 0V, and the source line voltage Vsig output from the source driver SD is in a range between 0 and +16V at the positive polarity or a range between −16 and 0V at the negative polarity.

FIG. 9 is a chart showing an example of the common voltage Vcom and the source line voltage Vsig in the transparent drive. The waveform of the source line voltage Vsig is represented by a solid line, and the waveform of the common voltage Vcom is represented by a two-dot chain line.

As shown in FIG. 9, the common voltage Vcom is switched alternately to 0V and 16V in each frame period Pf, similarly to the example shown in FIG. 8. In the transparent drive, the voltage value of the source line voltage Vsig matches the common voltage Vcom (Vsig=Vcom=0V or Vsig=Vcom=16V) in each frame period Pf. In FIG. 9, in view of a relationship in illustration between the source line voltage Vsig and the common voltage Vcom, both of them are slightly shifted. For this reason, the voltage of 0V is applied to the liquid crystal layer 30. In other words, the second transparent voltage VA2 is applied to the liquid crystal layer 30.

However, the source line voltage Vsig in the transparent drive is not limited to the example shown in FIG. 9. For example, the source line voltage Vsig may be higher than 0V and less than 8V (0V<Vsig<8V) in a period when the common voltage Vcom becomes 0V. The source line voltage Vsig may be higher than 8V and less than 16V (8V<Vsig<16V) in a period when the common voltage Vcom becomes 16V. In either of the cases, according to the transparent drive, an absolute value of the difference between the source line voltage Vsig and the common voltage Vcom is less than 8V and the parallelism of the light transmitted through the liquid crystal layer 30 is increased. In other words, the second transparent voltage VA2 is not limited to 0V, but an absolute value of the second transparent voltage VA2 may be less than 8V.

Incidentally, in the transparent drive, the voltage to be applied to the liquid crystal layer 30 may be less than the lower limit (for example, 8V) of the gradation, and the source line voltage Vsig may not completely match the common voltage Vcom. As described above, the degree of scattering in a case where the degree of scattering of the light made incident on the liquid crystal layer 30 is the highest when the scattering voltage VB is applied to the liquid crystal layer 30 is assumed to be 100%. For example, the second transparent voltage VA2 is desirably a voltage having the degree of scattering lower than 10%.

FIG. 10 is a chart showing another example of the common voltage Vcom and the source line voltage Vsig in the transparent drive. The waveform of the source line voltage Vsig is represented by a solid line, and the waveform of the common voltage Vcom is represented by a two-dot chain line.

As shown in FIG. 10, in this example, the polarity inversion of the common voltage Vcom and the source line voltage Vsig is stopped in the transparent drive. Furthermore, the common voltage Vcom and the source line voltage Vsig match at 8V (above reference voltage Vsig-c). Incidentally, the common voltage Vcom and the source line voltage Vsig may match at a voltage other than the reference voltage Vsig-c, such as 0V. In addition, it is desirable that the second transparent voltage VA2 is a voltage with the degree of scattering in a range lower than 10%, similarly to the case shown in FIG. 9.

The one-line inversion drive scheme has been described above as the example of the transparent drive, but similar transparent drive can be applied to a line-inversion drive scheme of two or more lines and a frame inversion drive scheme.

Next, a configuration example of the timing controller TC will be described. A drive scheme in which one frame period includes a plurality of sub-frame (field) periods will be applied to the display device DSP. Such a drive scheme is referred to as, for example, field sequential system. Red, green, and blue images are displayed in the respective sub-frame periods. The images of the colors displayed in time division are mixed and visually recognized as multi-color display image for the user.

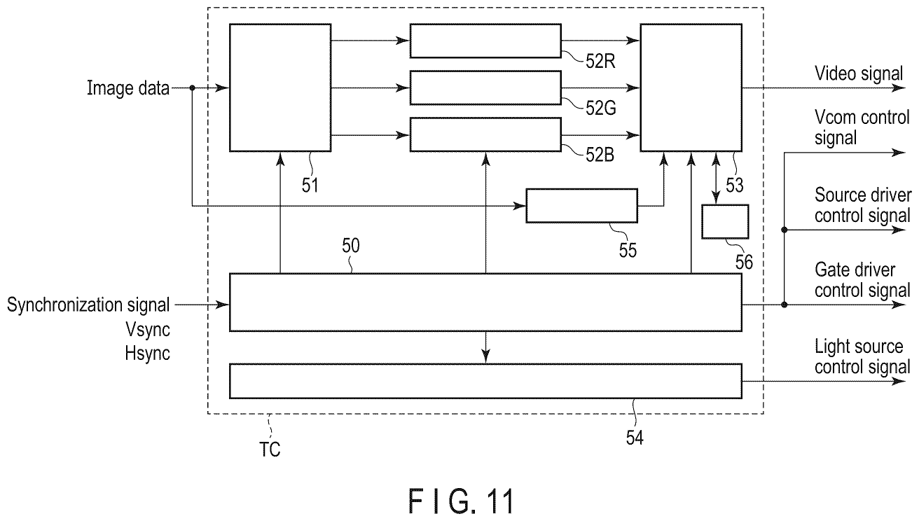

FIG. 11 is a diagram showing a configuration example of the timing controller TC shown in FIG. 3.

As shown in FIG. 11, the timing controller TC comprises a timing generation unit 50, a frame memory 51, line memories 52R, 52G, and 52B, a data conversion unit 53, a light source control unit 54, a detection unit 55 serving as an address detection unit, and the like.

The frame memory 51 stores image data for one frame input from the outside. The line memories 52R, 52G, and 52B store sub-frame data of red, green, and blue colors, respectively. The sub-frame data represent red, green, and blue images (for example, gradation values of the pixels PX) which the pixels PX are urged to display in time division. The sub-frame data of each of the colors stored in the line memories 52R, 52G, and 52B corresponds to a previous frame of the image data stored in the frame memory 51.

The data conversion unit 53 processes the sub-frame data of the colors stored in the line memories 52R, 52G, and 52B by various types of data conversion processing such as gamma correction, generates a video signal, and outputs the video signal to the above-described source driver SD. Incidentally, the timing controller TC may be configured to send RGB data to the data conversion unit 53 by allocating the RGB data in the frame memory 51. In this case, the timing controller TC can also be constituted without the line memories 52R, 52G, and 52B.

The light source control unit 54 outputs the light source control signal to the above-described light source driver LSD. The light source driver LSD drives the light emitting elements LSR, LSG, and LSB in accordance with the light source control signal. The light emitting elements LSR, LSG, and LSB can be driven under, for example, pulse width modulation (PWM) control. In other words, the light source driver LSD can adjust the luminance of each of the light emitting elements LSR, LSG, and LSB with the duty ratios of the signals output to the light emitting elements LSR, LSG, and LSB.

The timing generation unit 50 controls the operation timing of the frame memory 51, the line memories 52R, 52G, and 52B, the data conversion unit 53, and the light source control unit 54, in synchronization with a vertical synchronization signal Vsync and a horizontal synchronization signal Hsync that are input from the outside. In addition, the timing generation unit 50 controls the source driver SD by outputting a source driver control signal, controls the gate driver GD by outputting a gate driver control signal, and outputs a Vcom control signal.

The detection unit 55 is configured, when image data for one frame input from the outside includes data of an image, to detect an address of the data of the image. Examples of the image include a character displayed in a part of the display area DA. Examples of the character include a symbol including a letter, a figure, an icon, and the like. In addition, a case where data of the character is included in the image data means a case where data other than 0 is included in at least one piece of all bits of digital data. Address information of the data of the image is supplied to the data conversion unit 53. For this reason, when the image data input from the outside includes the data of the image, the timing controller TC can generate the processed video signal and output the processed video signal to the source driver SD in order to adjust the degree of scattering (transparency) of an area other than the area where the image is displayed. Generation of the processed video signal can be executed by calculation of the data conversion unit 53 or can be executed by using data stored in a table 56 of the timing controller TC.

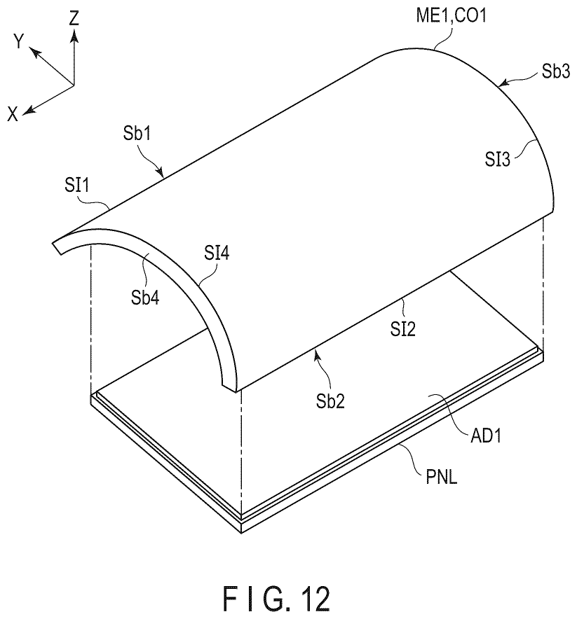

Next, a process of adhering the display panel PNL to the cover panel CO1 in the method of manufacturing the display device DSP of the present embodiment will be described. FIG. 12 is an exploded perspective view showing the display panel PNL and the cover panel CO1 of the display device DSP, illustrating a state in which the display panel PNL is to be adhered to the cover panel CO1.

As shown in FIG. 12, the cover panel CO1 is prepared. The transparent substrate ME1 of the cover panel CO1 is curved. The transparent substrate ME1 is curved such that the main surface Sa2 side is convex. However, the transparent substrate ME1 may be curved such the main surface Sa1 side is convex.

The transparent substrate ME1 further has a side surface Sb3 and a side surface Sb4. Each of the side surfaces Sb1 and Sb2 extends straight. More specifically, the long side SI1 of the side surface Sb1 and the long side SI2 of the side surface Sb2 are straight. In contrast, each of the side surfaces Sb3 and Sb4 extends to be curved. More specifically, the long side SI3 of the side surface Sb3 and the long side SI4 of the side surface Sb4 are curved. Based on the above, the side surface Sb1 opposed to the light emitting element LS is a non-curved surface. The cross-section of the transparent substrate ME1 on the Y-Z plane is not curved, but the cross-section of the transparent substrate ME1 on the X-Z plane is curved.

Then, the display panel PNL is adhered to the cover panel CO1. At this time, the adhesive sheet AD1 is adhered to one of the display panel PNL and the cover panel CO1. In this example, the adhesive sheet AD1 is adhered to the display panel PNL. After that, the display panel PNL and the cover panel CO1 are opposed to each other. The display panel PNL is not curved before the display panel PNL is adhered to the cover panel CO1. After that, the display panel PNL is pressed against the cover panel CO1, and the display panel PNL is adhered to the cover panel CO1. The display panel PNL is thereby curved according to the cover panel CO1.

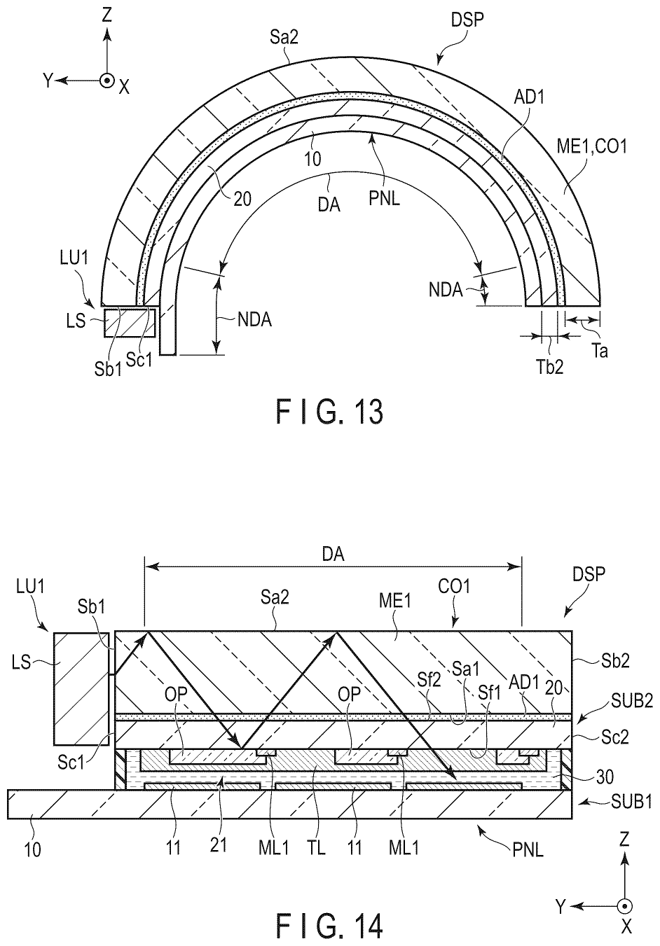

FIG. 13 is a cross-sectional view showing the display device DSP of the present embodiment. FIG. 13 shows only the basement 10 and the basement 20 of the display panel PNL.

As shown in FIG. 13, the cover panel CO1 (transparent substrate ME1), the adhesive sheet AD1, and the display panel PNL are curved such that the main surface Sa2 side is convex, in the cross-section of the display device DSP on a virtual plane parallel to the Y-Z plane.

The light emitting element LS is composed of, for example, a light emitting diode. However, the light emitting element LS may be a laser or a laser diode. In such a case, it is desirable to provide a lens between the light emitting element LS and the side surfaces Sb1 and Sc1, spread the light emitted from the light emitting element LS in the X-Y plane direction, and make the light incident on the side surfaces Sb1 and Sc1.

The light emitting element LS can emit light onto the side surface Sb1 of the transparent substrate ME1 having the thickness Ta. Since the size of the light emitting element LS opposed to the side surface Sb1 can be increased, the luminance level of the light emitted from the light emitting element LS can be increased in proportion to the above-described size. Therefore, the user can visually recognize the display image of the display device DSP desirably.

In the present embodiment, the side surfaces Sb1 and Sc1 are desirably located on the same plane. The side surface Sb1 and the side surface Sc1 may not be located on the same plane, but displaced from the same plane due to intersection of cutting and bonding in manufacturing. In addition, the light emitting element LS is opposed to not only the side surface Sb1 of the transparent substrate ME1 but also the side surface Sc1 of the basement 20. The size of the light emitting element LS can be further increased, and the luminance level of the light emitted from the light emitting element LS can be further increased. Therefore, the user can visually recognize the display image of the display device DSP further desirably.

FIG. 14 is a developed cross-sectional view showing the display device DSP of the present embodiment, showing a plurality of metal lines ML1, a plurality of optical layers OP, and the like.

As shown in FIG. 14, the common electrode 21 includes a transparent conductive layer TL and a plurality of metal lines ML1. The transparent conductive layer TL is located between the main surface Sf1 of the basement 20 and the liquid crystal layer 30. The transparent conductive layer TL is formed of a transparent conductive material such as ITO or IZO.

The metal lines ML1 are located between the main surface Sf1 and the transparent conductive layer TL and are formed of metal. The metal lines ML1 are in contact with the transparent conductive layer TL. Since the common electrode 21 comprises the metal lines ML1, the resistance of the common electrode 21 can be lowered.

The second substrate SUB2 comprises a plurality of optical layers OP. In the present embodiment, the optical layers OP function as first optical layers. The optical layers OP are located between the main surface Sf1 of the basement 20 and the transparent conductive layer TL and overlap with the corresponding metal lines ML1.

Each of the basement 20 and the transparent substrate ME1 is formed of glass. The refractive index of each of the basement 20 and the transparent substrate ME1 is 1.51. The adhesive sheet AD1 is formed of OCA. The refractive index of the adhesive sheet AD1 is equivalent to that of the basement 20. In this example, “equivalent” is not limited to a case where the difference in refractive index is zero, but indicates a case where the difference in refractive index is less than 0.05. The transparent conductive layer TL is formed of ITO. The refractive index of the transparent conductive layer TL is equivalent to that of the basement 20. The optical layer OP is formed of an organic material such as siloxane-based resin or fluorine-based resin. The refractive index of the optical layer OP is substantially 1.0 to 1.48.

The refractive index of the optical layer OP is lower than that of the basement 20. In this case, the refractive index of the optical layer OP being lower than that of the basement 20 implies a case where a difference in refractive index between the optical layer OP and the basement 20 is 0.03 or higher. The optical reflectance at the interface between the basement 20 and the optical layer OP is higher than the optical reflectance at the interface between the basement 20 and the transparent conductive layer TL.

Light can hardly escape from the basement 20 to the optical layer OP. Light made incident from the side surface Sb1 and the side surface Sc1 can desirably propagate to the side surface Sb2 and the side surface Sc2 inside the basement 20 and the transparent substrate ME1, respectively. Therefore, the situation in which the brightness of the image displayed by the display device DSP is different on the side surface Sc1 side and the side surface Sc2 side can be suppressed.

The optical layers OP overlap with the metal lines ML1. The optical layers OP can suppress the scattering (reflection) of light, which is caused by the metal lines ML1. Undesired bright spots are less likely to occur in the display area DA, and the contrast ratio of the display device DSP can be increased.

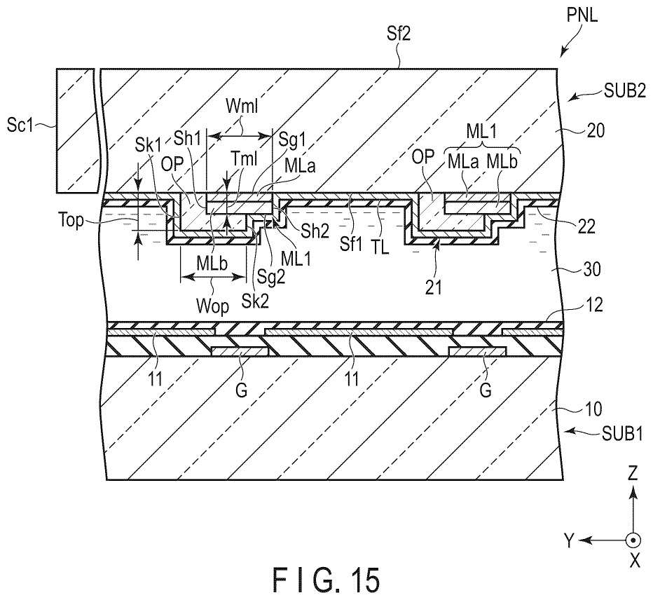

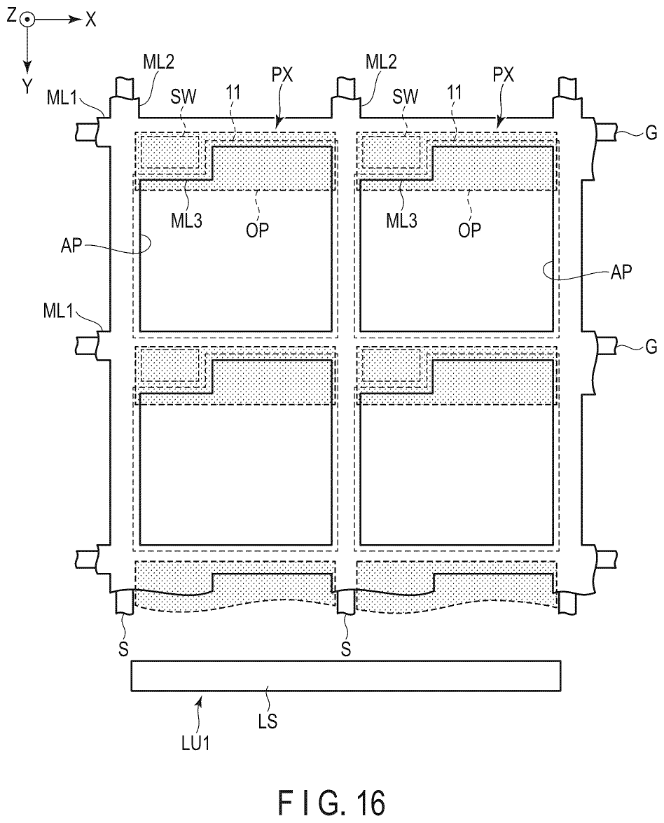

FIG. 15 is an enlarged cross-sectional view showing parts of the display panel PNL of the present embodiment, showing the plurality of metal lines ML1, the plurality of optical layers OP, and the like. FIG. 16 is an enlarged plan view showing parts of the display panel PNL of the present embodiment, showing the plurality of metal lines ML1 and ML2, the plurality of optical layers OP, and the like. FIG. 15 and FIG. 16 show only the main parts necessary for the descriptions with respect to the display panel PNL. In FIG. 16, the optical layers OP are marked with a dot pattern.

As shown in FIG. 15 and FIG. 16, the common electrode 21 further comprises a plurality of metal lines ML2 and a plurality of metal layers ML3. The plurality of metal lines ML1 extend in the first direction X and are arranged to be spaced apart in the second direction Y. The metal lines ML1 overlap with the corresponding gate lines G. The plurality of metal lines ML2 extend in the second direction Y and are arranged to be spaced apart in the first direction X. The metal lines ML2 overlap with the corresponding source lines S. The metal layer ML3 is located near an intersection of the corresponding gate line G and the corresponding source line S and overlaps with the corresponding switching element SW.

The plurality of metal lines ML1, the plurality of metal lines ML2, and the plurality of metal layers ML3 are formed of the same material and formed in the same layer. The plurality of metal lines ML1, the plurality of metal lines ML2, and the plurality of metal layers ML3 are formed in one piece. The plurality of metal lines ML1, the plurality of metal lines ML2, and the plurality of metal layers ML3 function as a black matrix and form a plurality of apertures AP of the plurality of pixels PX.

The plurality of optical layers OP are arrayed in a matrix in the first direction X and the second direction Y. The plurality of optical layers OP correspond to the pixels PX in a one-on-one relationship and are physically provided independently of each other.

The metal lines ML1, the metal lines ML2, and the metal layer ML3 are in contact with the main surface Sf1 of the basement 20. The optical layers OP are located between the metal lines ML1 and the transparent conductive layer TL, and are in contact with the main surface Sf1 of the basement 20 and the metal lines ML1. The optical layers OP are located on the transparent conductive layer TL side with respect to the metal lines ML1. The transparent conductive layer TL is in contact with parts of the metal lines ML1, which are not in contact with the basement 20 and the optical layers OP.

As shown in FIG. 15, the metal line ML1 has a main surface Sg1, a main surface Sg2, a side surface Sh1, and a side surface Sh2. The main surface Sg1 is in contact with the main surface Sf1 of the basement 20. The main surface Sg2 is located on a side opposite to the main surface Sg1. The side surface Sh1 is located between the main surface Sg1 and the main surface Sg2. The side surface Sh1 of the metal line ML1 is located on the side surface Sc1 side. The side surface Sh2 is located between the main surface Sg1 and the main surface Sg2. The side surface Sh2 of the metal line ML1 is located on a side opposite to the side surface Sc1. The main surface Sg1 functions as a third main surface, the main surface Sg2 functions as a fourth main surface, and the side surface Sh1 functions as a second side surface.

The optical layer OP has a side surface Sk1 and a side surface Sk2. In the optical layer OP, the side surface Sk1 is located on the side surface Sc1 side. In the optical layer OP, the side surface Sk2 is located on a side opposite to the side surface Sk1.

The optical layer OP has a thickness Top. The thickness Top is the height in the third direction Z from the surface in contact with the main surface Sf1 to the surface in contact with the transparent conductive layer TL, in the area which does not overlap with the metal line ML1. The metal line ML1 has a thickness Tm1. The thickness Tm1 is the height in the third direction Z from the main surface Sg1 to the main surface Sg2.

The thickness Top of the optical layer OP is larger than the thickness Tm1 of the metal line ML1. The optical layer OP can cover the entire side surface Sh1 of the metal line ML1. Therefore, the optical layer OP can suppress the incidence of light to the side surface Sh1.

The optical layer OP is in contact with each of the portion of the main surface Sf1 of the basement 20, which is on the side surface Sc1 side from the metal line ML1, the side surface Sh1 of the metal line ML1, and the main surface Sg2 of the metal line ML1. The side surface Sh1 is exposed more easily to light than the side surface Sh2 since the side surface Sh1 faces the side surface Sc1 (light emitting element LS) side. The optical layer OP can cover the side surface Sh1 which faces the side surface Sc1 (light emitting element LS) side. Therefore, light scattering (reflection) on the side surface Sh1 can be suppressed.

In the direction in which light is emitted from the first light source unit LU1 (light emitting element LS) (i.e., the direction opposite to the second direction Y), a width Wop of the optical layer OP is larger than the width Wml of the metal line ML1.

Each of the metal line ML1, the metal line ML2, and the metal layer ML3 has a first metal layer MLa and a second metal layer MLb. The first metal layer MLa is in contact with the main surface Sf1 of the basement 20. The second metal layer MLb is located on the transparent conductive layer TL side with respect to the first metal layer MLa and is stacked on the first metal layer MLa.

The first metal layer MLa is formed of, for example, aluminum (Al). The second metal layer MLb is formed of, for example, molybdenum-tungsten (MoW). Incidentally, the second metal layer MLb may be formed of molybdenum (Mo), tungsten (W), or chromium (Cr).

The light reflectance of the first metal layer MLa is higher than that of the second metal layer MLb. Light absorption in the first metal layer MLa can be suppressed as compared to a case where the second metal layer MLb is located on the basement 20 side with respect to the first metal layer MLa. Light can be desirably propagated through the basement 20, the transparent substrate ME1, and the like. The conductivity of the first metal layer MLa is higher than that of the second metal layer MLb. As a result, the resistance of the common electrode 21 can be further lowered.

Incidentally, each of the metal line ML1, the metal line ML2, and the metal layer ML3 has a two-layer stacked structure, but each may have a three-layer stacked structure or each may be formed with a single metal layer.

According to the display device DSP of the first embodiment configured as described above, the display device DSP comprises the display panel PNL. The display panel PNL includes the first substrate SUB1, the second substrate SUB2, and the liquid crystal layer 30. The second substrate SUB2 includes the basement 20, the transparent conductive layer TL, the metal lines ML1, and the optical layers OP. When light is made incident on the metal lines ML1, the light is scattered by the metal lines ML1, and undesired bright spots are generated in the display area DA.

For this reason, the second substrate SUB2 comprises the optical layers OP. The optical layers OP are located between the main surface Sf1 and the transparent conductive layer TL, are made to overlap with the metal lines ML1, and have a refractive index lower than that of the basement 20. The optical layers OP can suppress the scattering (reflection) of light, which is caused by the metal lines ML1. Undesired bright spots are less likely to occur in the display area DA, and the contrast ratio of the display device DSP can be increased.

In addition, the user can easily visually recognize the images (characters) displayed on the display device DSP. Therefore, the display device DSP capable of increasing the display quality can be obtained.

The optical layers OP are provided between the basement 20 and the liquid crystal layer 30. The distance in the third direction Z from the optical layers OP to the liquid crystal layer 30 is shorter than that in the case where the optical layers OP are provided between the transparent substrate ME1 and the basement 20. In the present embodiment, however, the optical layers OP are provided for the respective pixels PX. Since the amount of light made incident on the liquid crystal layer 30 can be made uniform over the entire display area DA, the optical layers OP can contribute to further improvement of the display quality. In addition to the above, various suitable advantages can be obtained from the present embodiment.

### Modified Example 1 of First Embodiment

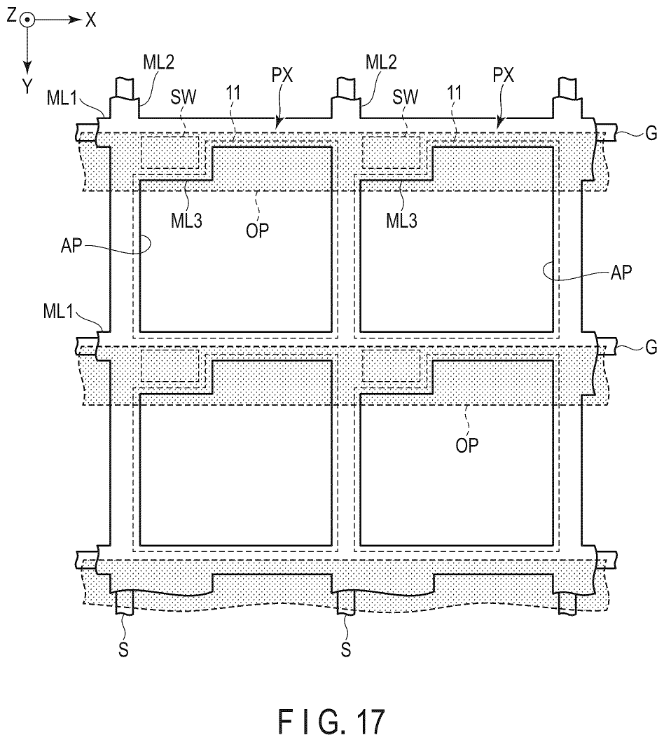

Next, modified example 1 of the first embodiment will be described. The display device DSP is configured in the same manner as the display device DSP of the above-described first embodiment except for the configuration described in modified example 1. FIG. 17 is an enlarged plan view showing parts of the display panel PNL of modified example 1, showing the plurality of metal lines ML1 and ML2, the plurality of optical layers OP, and the like. Incidentally, in FIG. 17, the optical layers OP are marked with dot patterns.

As shown in FIG. 17, the optical layers OP may extend continuously in the first direction X. One of the optical layers OP is shared by a plurality of pixels PX aligned in the first direction X.

In modified example 1, the same advantages as those of the above-described first embodiment can also be obtained.

### Second Embodiment

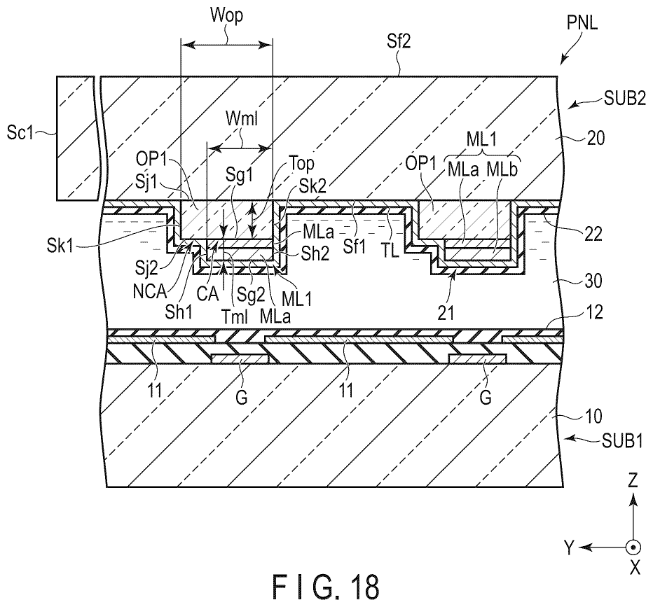

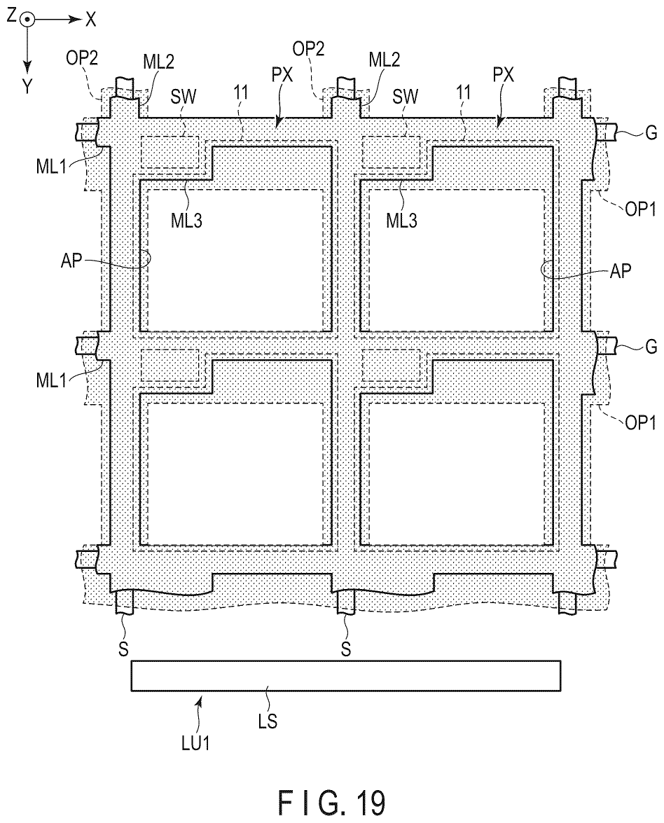

Next, a second embodiment will be described. The display device DSP is configured in the same manner as the display device DSP of the above-described first embodiment except for the configuration described in the second embodiment. FIG. 18 is an enlarged cross-sectional view showing parts of the display panel PNL of the display device DSP of the second embodiment, showing a plurality of metal lines ML1, a plurality of optical layers OP, and the like. FIG. 19 is an enlarged plan view showing parts of the display panel PNL of the second embodiment, showing the plurality of metal lines ML1, the plurality of optical layers OP, and the like. Incidentally, in the second embodiment, the display device DSP is not curved. FIG. 18 and FIG. 19 show only the main parts necessary for description with respect to the display panel PNL. Incidentally, in FIG. 19, the optical layers OP are marked with dot patterns.

As shown in FIG. 18 and FIG. 19, the second substrate SUB2 comprises a plurality of optical layers OP1 and a plurality of optical layers OP2 instead of a plurality of optical layers OP. The physical properties of each of the optical layers OP1 and optical layers OP2 are the same as the physical properties of the above-described optical layers OP. In the present embodiment, the optical layers OP1 function as first optical layers.

The plurality of optical layers OP1 extend in the first direction X and are arranged to be spaced apart in the second direction Y. The optical layers OP1 overlap with corresponding gate lines G and also function as pedestals for the gate lines G. The plurality of optical layers OP2 extend in the second direction Y and are arranged to be spaced apart in the first direction X. The optical layers OP2 overlap with corresponding source lines S and also function as pedestals for the source lines S. The plurality of optical layers OP1 and the plurality of optical layers OP2 are formed of the same material and formed in the same layer. The plurality of optical layers OP1 and the plurality of optical layers OP2 are formed integrally to cross each other.

The optical layer OP1 and the optical layer OP2 are in contact with the main surface Sf1 of the basement 20. The metal line ML1 is located between the optical layer OP1 and the transparent conductive layer TL and is in contact with the optical layer OP1. The metal line ML1 is located on the transparent conductive layer TL side with respect to the optical layer OP1. Similarly, the metal line ML2 is located between the optical layer OP2 and the transparent conductive layer TL and is in contact with the optical layer OP2. The metal line ML2 is located on the transparent conductive layer TL side with respect to the optical layer OP2.

The transparent conductive layer TL is in contact with parts of the metal lines ML1, which are not in contact with the optical layers OP1. In addition, the transparent conductive layer TL is in contact with parts of the metal lines ML2, which are not in contact with the optical layers OP2.

In the direction in which light is emitted from the first light source unit LU1 (light emitting element LS) (i.e., the direction opposite to the second direction Y), a width Wop of the optical layer OP1 is larger than the width Wml of the metal line ML1. Since the optical layer OP1 can easily suppress light transmitted through the main surface Sf1 of the basement 20 to the metal line ML1, the optical layer OP1 can suppress scattering (reflection) of light in the metal line ML1 (for example, side surface Sh1).

Similarly, the width of the optical layer OP2 is larger than the width of the metal line ML2, in the first direction X. The optical layer OP2 can suppress scattering (reflection) of light in the metal line ML2 (for example, side surface of the metal line ML2).

As shown in FIG. 18, the optical layer OP1 has a main surface Sj1 and a main surface Sj2. The main surface Sj1 is in contact with the main surface Sf1 of the basement 20. The main surface Sj2 is located on a side opposite to the main surface Sj1. The main surface Sj1 functions as a fifth main surface, and the main surface Sj2 functions as a sixth main surface. The main surface Sj2 has a contact area CA and a non-contact area NCA. In the second direction Y, the non-contact area NCA is located on the side surface Sc1 side with respect to the contact area CA. The metal line ML1 is in contact with the contact area CA of the main surface Sj2. Since light transmitted through the main surface Sf1 of the basement 20 becomes further difficult to hit the side surface Sh1 of the metal line ML1, scattering of light on the side surface Sh1 can be suppressed.

The optical layer OP1 has a thickness Top. The thickness Top is the height in the third direction Z from the main surface Sj1 to the main surface Sj2. The metal line ML1 has a thickness Tm1. The thickness Tm1 is the height in the third direction Z from the main surface Sg1 to the main surface Sg2. The thickness Top of the optical layer OP1 is larger than the thickness Tm1 of the metal line ML1. For this reason, the optical layer OP1 can further suppress the incidence of light on the side surface Sh1.

Each of the metal line ML1, the metal line ML2, and the metal layer ML3 has a first metal layer MLa and a second metal layer MLb. When the metal line ML1 is focused, the first metal layer MLa of the metal line ML1 is in contact with the main surface Sj2 of the optical layer OP1. The second metal layer MLb is located on the transparent conductive layer TL side with respect to the first metal layer MLa and is stacked on the first metal layer MLa. The first metal layer MLa is formed of, for example, Al. The second metal layer MLb is formed of, for example, MoW.

The light reflectance of the first metal layer MLa is higher than that of the second metal layer MLb. Light absorption in the first metal layer MLa can be suppressed as compared to a case where the second metal layer MLb is located on the basement 20 side with respect to the first metal layer MLa. Even if light is transmitted through the optical layer OP1 and is made incident on the first metal layer MLa, the first metal layer MLa can desirably reflect the light to the basement 20 side, and light can be made to desirably propagate the basement 20, the transparent substrate ME1, and the like. The conductivity of the first metal layer MLa is higher than that of the second metal layer MLb. As a result, the resistance of the common electrode 21 can be further lowered.

Incidentally, each of the metal line ML1, the metal line ML2, and the metal layer ML3 has a two-layer stacked structure, but each may have a three-layer stacked structure or each may be formed with a single metal layer.

In the display device DSP of the second embodiment configured as described above as well, the same advantages as those of the first embodiment can be obtained, and the display device DSP capable of improving the display quality can be obtained.

### Third Embodiment

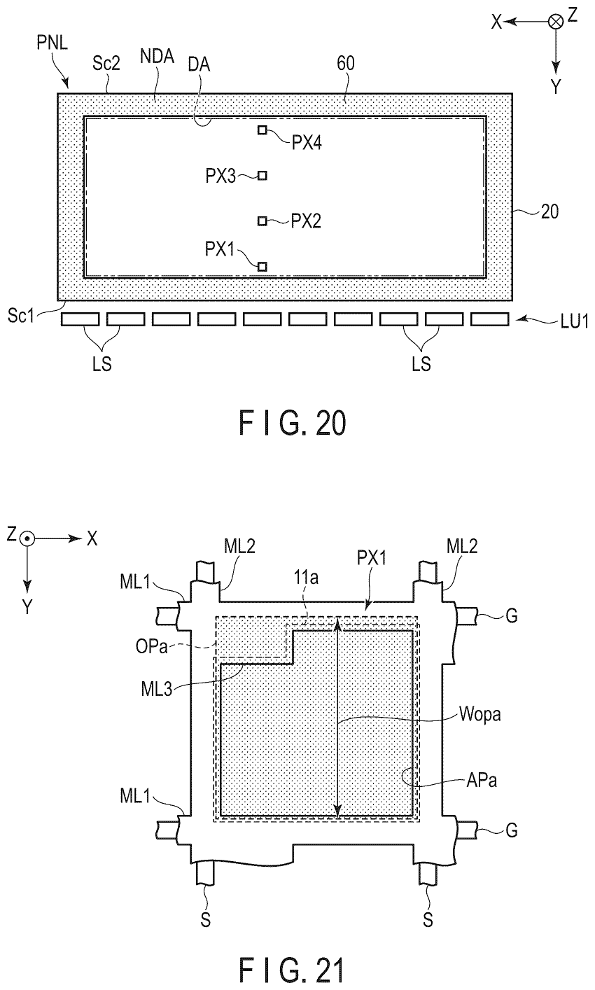

Next, a third embodiment will be described. The display device DSP is configured in the same manner as the display device DSP of the first embodiment except for the configuration described in the third embodiment. FIG. 20 is a plan view showing a display panel PNL and first light source units LU1 of the third embodiment. Incidentally, in FIG. 20, an optical layer 60 is marked with dot patterns.

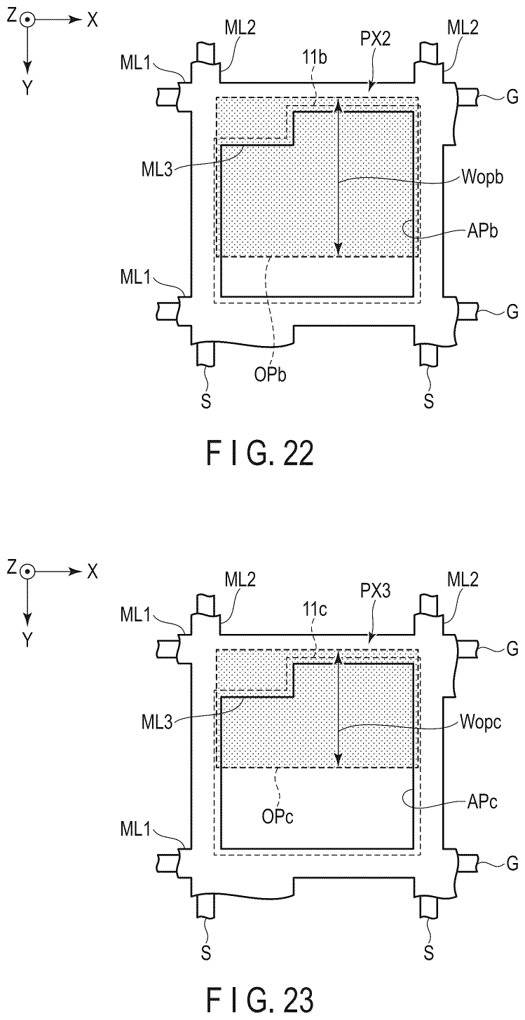

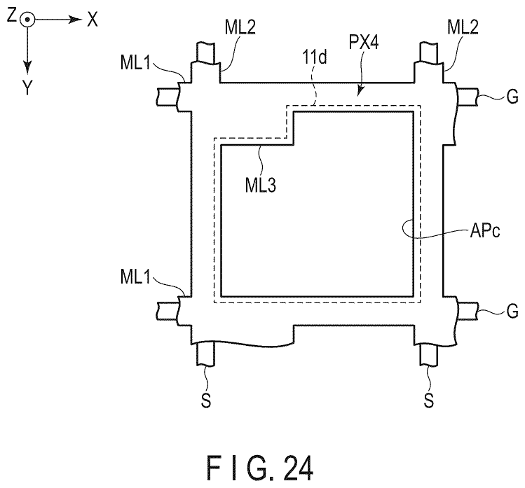

FIG. 21 is an expanded plan view showing a first pixel PX1 of a plurality of pixels PX on a display panel PNL of the third embodiment. FIG. 22 is an expanded plan view showing a second pixel PX2 of the plurality of pixels PX on the display panel PNL of the third embodiment. FIG. 23 is an expanded plan view showing a third pixel PX3 of the plurality of pixels PX on the display panel PNL of the third embodiment. FIG. 24 is an expanded plan view showing a fourth pixel PX4 of the plurality of pixels PX on the display panel PNL of the third embodiment.

In FIG. 21 to FIG. 23, the optical layers OP are marked with dot patterns. Incidentally, in the third embodiment, the display device DSP is not curved. FIG. 20 to FIG. 24 show only the main parts necessary for description with respect to the display panel PNL. In FIG. 20, illustration of the basement 10 and the like is omitted.

As shown in FIG. 20, the plurality of pixels PX includes the first pixel PX1, the second pixel PX2, the third pixel PX3, and the fourth pixel PX4. The second pixel PX2 is located between the first pixel PX1 and the side surface Sc2 of the basement 20. The third pixel PX3 is located between the second pixel PX2 and the side surface Sc2. The fourth pixel PX4 is located between the third pixel PX3 and the side surface Sc2.

The second substrate SUB2 further comprises the optical layer 60. The optical layer 60 is located in the non-display area NDA and is formed in a rectangular frame shape. Incidentally, the optical layer 60 and the optical layer OP are simultaneously formed of the same material. The physical properties of the optical layer 60 and the optical layer OP are the same as each other.

As shown in FIG. 20 and FIG. 21, the first pixel PX1 comprises a first pixel electrode 11a of the plurality of pixel electrodes 11, an optical layer OPa of the plurality of optical layers OP, and an aperture APa of the plurality of apertures AP. The plurality of pixel electrodes 11 are formed under the same conditions. The plurality of apertures AP are formed under the same conditions. The plurality of optical layers OP are formed under conditions different depending on the location of the pixels PX.

The first pixel electrode 11a overlaps with the entire area of at least the aperture APa. The optical layer OPa faces the first pixel electrode 11a. In the present embodiment, the optical layer OPa faces the entire first pixel electrode 11a. In addition, the optical layer OPa overlaps with the entire area of the aperture APa. The optical layer OPa has a width Wopa in the second direction Y. In the present embodiment, the optical layer OPa functions as the first optical layer.

As shown in FIG. 20 and FIG. 22, the second pixel PX2 comprises a second pixel electrode 11b of the plurality of pixel electrodes 11, an optical layer OPb of the plurality of optical layers OP, and an aperture APb of the plurality of apertures AP. Incidentally, the above-described first pixel electrode 11a is located between the side surface Sc1 of the basement 20 and the second pixel electrode 11b.

The optical layer OPb faces the second pixel electrode 11b. In the present embodiment, the optical layer OPb faces several parts of the second pixel electrode 11b. In addition, the optical layer OPb overlaps with a partial area of the aperture APb. For example, the optical layer OPb overlaps with 75% of the second pixel electrode 11b. In the present embodiment, the optical layer OPb functions as the second optical layer. The optical layer OPb has a width Wopb in the second direction Y. In the present embodiment, the width Wopb is smaller than the width Wopa. The size of the optical layer OPa is larger than the size of the optical layer OPb, in plan view.

As shown in FIG. 20 and FIG. 23, the third pixel PX3 comprises a third pixel electrode 11c of the plurality of pixel electrodes 11, an optical layer OPc of the plurality of optical layers OP, and an aperture APc of the plurality of apertures AP. Incidentally, the above-described second pixel electrode 11b is located between the first pixel electrode 11a and the third pixel electrode 11c.

The optical layer OPc faces the third pixel electrode 11c. In the present embodiment, the optical layer OPc faces several parts of the third pixel electrode 11c. In addition, the optical layer OPc overlaps with a partial area of the aperture APc. For example, the optical layer OPc overlaps with 50% of the third pixel electrode 11c. The optical layer OPc has a width Wopc in the second direction Y. In the present embodiment, the width Wopc is smaller than the width Wopb. The size of optical layer OPb is larger than the size of optical layer OPc, in plan view.

As shown in FIG. 20 and FIG. 24, the fourth pixel PX4 comprises a fourth pixel electrode 11d of the plurality of pixel electrodes 11, and an aperture APd of the plurality of apertures AP. Incidentally, the above-described third pixel electrode 11c is located between the second pixel electrode 11b and the fourth pixel electrode 11d. The fourth pixel PX4 does not comprise the optical layer OP.

In the display device DSP of the third embodiment configured as described above as well, the same advantages as those of the first embodiment can be obtained, and the display device DSP capable of improving the display quality can be obtained. In the display area DA, the optical layers OP are provided at regular intervals, but the size of the optical layers OP is smaller as the distance from the light emitting elements LS is longer. The amount of light made incident on the liquid crystal layer 30 can be made more uniform over the entire display area DA.

### Modified Example 1 of Third Embodiment

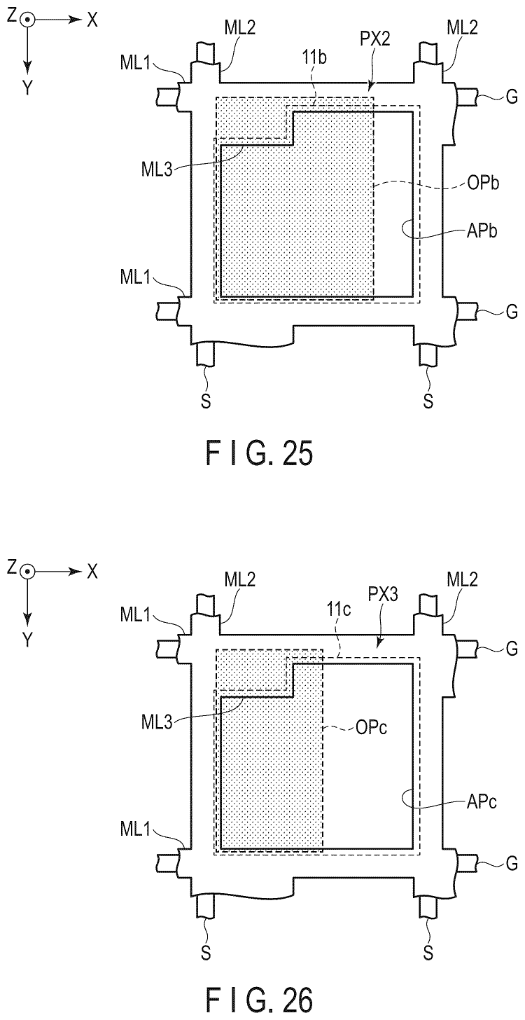

Next, modified example 1 of the third embodiment will be described. The display device DSP is configured in the same manner as the display device DSP of the above-described third embodiment except for the configuration described in modified example 1. FIG. 25 is an enlarged plan view showing the second pixel PX2 of the display panel PNL of modified example 1. FIG. 26 is an enlarged plan view showing the third pixel PX3 of the display panel PNL of modified example 1. Incidentally, in FIG. 25 and FIG. 26, the optical layers OP are marked with dot patterns.

As shown in FIG. 20, FIG. 25, and FIG. 26, the width of the optical layer OP in the first direction X may be adjusted when the size of the optical layers OP is made different. Incidentally, the width in the second direction Y of the plurality of optical layers OP is the same.

As shown in FIG. 20, FIG. 21, and FIG. 25, the width of the optical layer OPb is smaller than the width of the optical layer OPa in the first direction X.

As shown in FIG. 20, FIG. 25, and FIG. 26, the width of the optical layer OPc is smaller than the width of the optical layer OPb in the first direction X.

The same advantages as those of the above-described third embodiment can also be obtained in modified example 1.

### Modified Example 2 of Third Embodiment

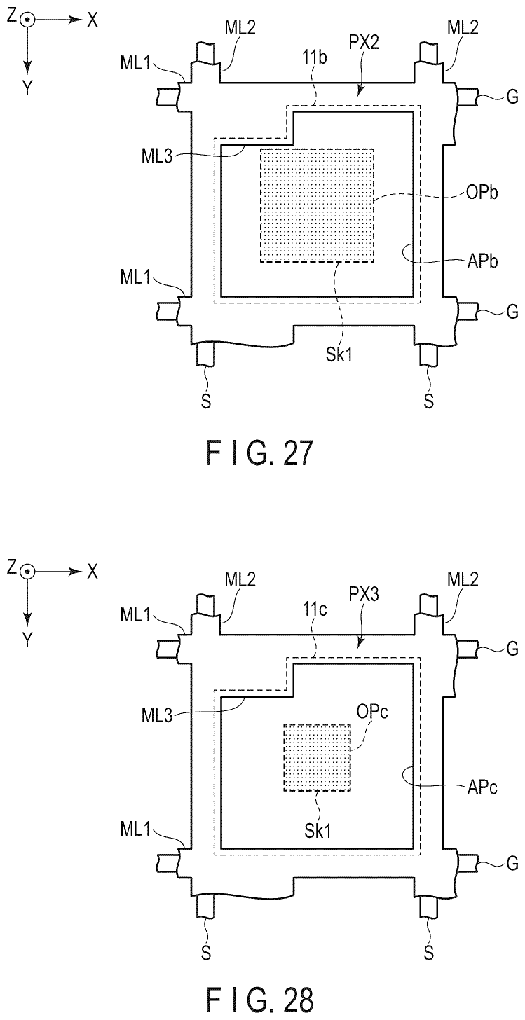

Next, modified example 2 of the third embodiment will be described. The display device DSP is configured in the same manner as the display device DSP of the above-described third embodiment except for the configuration described in modified example 2. FIG. 27 is an enlarged plan view showing the second pixel PX2 of the display panel PNL of modified example 2. FIG. 28 is an enlarged plan view showing the third pixel PX3 of the display panel PNL of modified example 2. Incidentally, in FIG. 27 and FIG. 28, the optical layers OP are marked with dot patterns.

As shown in FIG. 20, FIG. 27, and FIG. 28, both the width in the first direction X and the width in the second direction Y of the optical layer OP may be adjusted when the size of the optical layers OP is made different.

As shown in FIG. 20, FIG. 21, and FIG. 27, the center of gravity of the optical layer OPb is located in the center of the aperture APb. In addition, the width of the optical layer OPb is smaller than the width of the optical layer OPa, in the first direction X. In addition, the width of the optical layer OPb is smaller than the width of the optical layer OPa, in the second direction Y. The side surface Sk1 of the optical layer OPb is parallel to the first direction X.

As shown in FIG. 20, FIG. 27, and FIG. 28, the center of gravity of the optical layer OPc is located in the center of the aperture APc. The width of the optical layer OPc is smaller than the width of the optical layer OPb, in the first direction X. In addition, the width of the optical layer OPc is smaller than the width of the optical layer OPb, in the second direction Y. The side surface Sk1 of the optical layer OPc is parallel to the first direction X.

The same advantages as those of the above-described third embodiment can also be obtained in modified example 2.

### Modified Example 3 of Third Embodiment

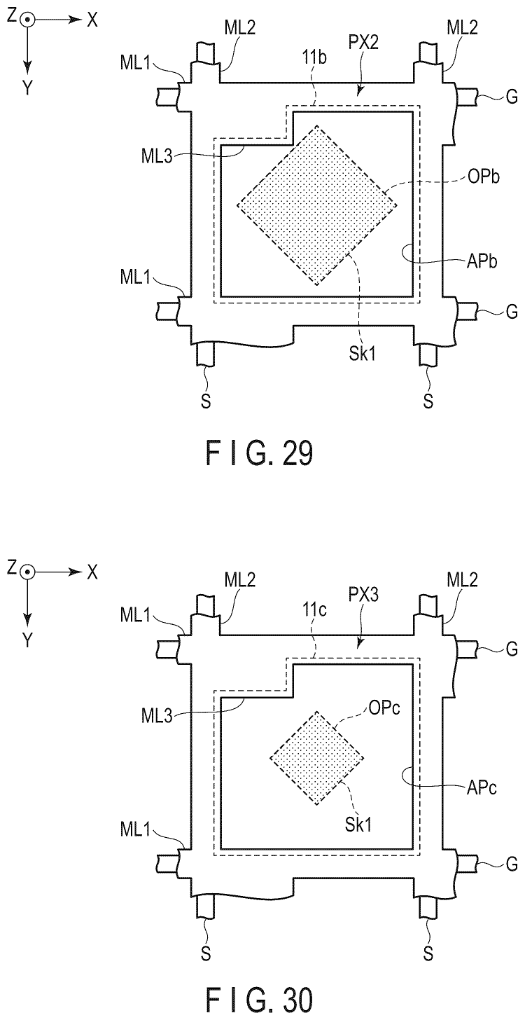

Next, modified example 3 of the third embodiment will be described. The display device DSP is configured in the same manner as the display device DSP of modified example 2 except for the configuration described in modified example 3. FIG. 29 is an enlarged plan view showing the second pixel PX2 of the display panel PNL of modified example 3. FIG. 30 is an enlarged plan view showing the third pixel PX3 of the display panel PNL of modified example 3. Incidentally, in FIG. 29 and FIG. 30, the optical layers OP are marked with dot patterns.

As shown in FIG. 29 and FIG. 30, the side surface Sk1 of the optical layer OP may be inclined from the first direction X. In modified example 3, the side surface Sk1 is inclined 45 degrees from the first direction X.

The same advantages as those of the above-described third embodiment can also be obtained in modified example 3. The side surface Sk1 of the optical layer OP is not parallel to the first direction X. Therefore, scattering of light at the edges of the optical layer OP, such as the side surface Sk1, can be suppressed.

### Modified Example 4 of Third Embodiment

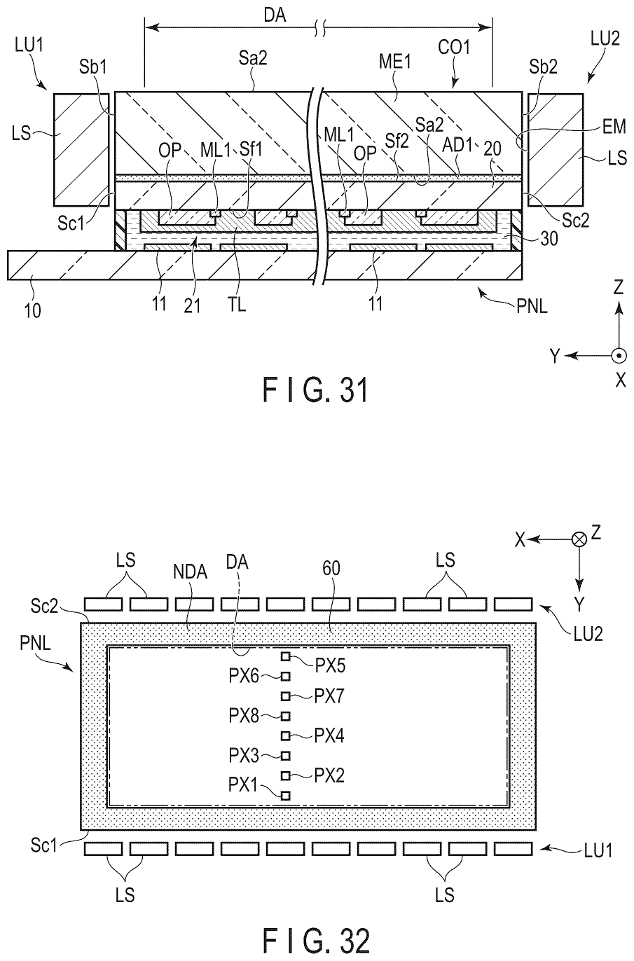

Next, modified example 4 of the third embodiment will be described. The display device DSP is configured in the same manner as the display device DSP of the above-described third embodiment except for the configuration described in modified example 4. FIG. 31 is a cross-sectional view showing the display device DSP of modified example 4, showing a plurality of metal lines ML1, a plurality of optical layers OP, and the like.

As shown in FIG. 31, the display device DSP comprises a second light source unit LU2. The first light source unit LU1 and the second light source unit LU2 can emit light to the transparent substrate ME1 and the basement 20 from both sides. The light emitting element LS of the second light source unit LU2 is located on the side surface Sc2 (side surface Sb2) side with respect to the display area DA in the second direction Y, and can emit light toward the display area DA. The light emitting element LS of the second light source unit LU2 includes a light emitting portion (light emitting surface) EM which is opposed to the side surface Sb2 and which emits light to the side surface Sb2.

The illumination light emitted from the light emitting portion EM is made incident on the side surface Sb2 and propagates through the transparent substrate ME1 (cover panel CO1), the adhesive sheet AD1, and the display panel PNL. In modified example 4, the light emitting portion EM is also opposed to the side surface Sc2 of the basement 20 and further emits light to the side surface Sc2.

FIG. 32 is a plan view showing the display panel PNL, the first light source units LU1, and the second light source units LU2 of modified example 4. Incidentally, in FIG. 32, an optical layer 60 is marked with dot patterns.

As shown in FIG. 32, the plurality of pixels PX includes a fifth pixel PX5, a sixth pixel PX6, a seventh pixel PX7, and an eighth pixel PX8 in addition to the first pixel PX1, the second pixel PX2, the third pixel PX3, and the fourth pixel PX4. The fifth pixel PX5 is located between the side surface Sc2 of the basement 20 and the sixth pixel PX6. The sixth pixel PX6 is located between the fifth pixel PX5 and the seventh pixel PX7. The seventh pixel PX7 is located between the sixth pixel PX6 and the eighth pixel PX8. The eighth pixel PX8 is located between the seventh pixel PX7 and the fourth pixel PX4. The fifth pixel PX5 is configured in the same manner as the first pixel PX1 shown in FIG. 21. The eighth pixel PX8 is configured in the same manner as the fourth pixel PX4 shown in FIG. 24.

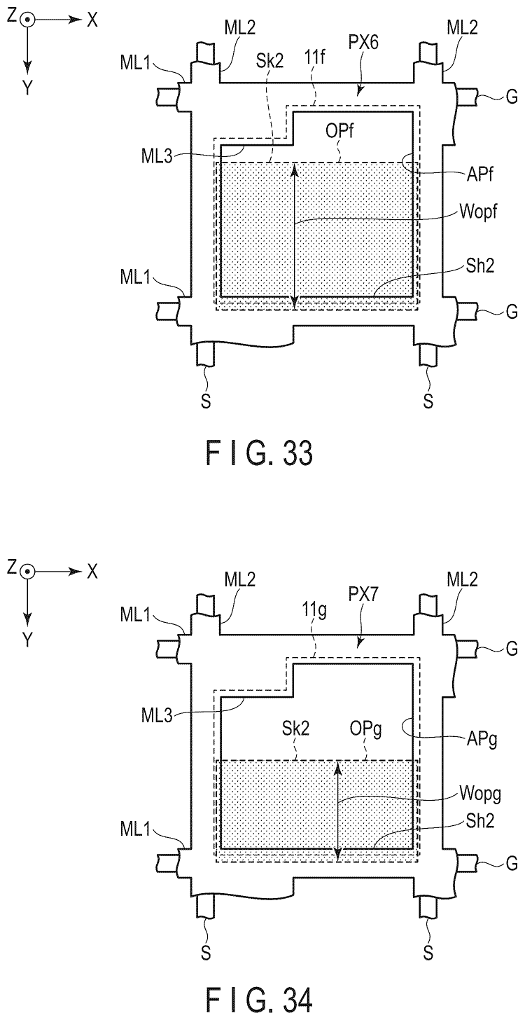

FIG. 33 is an enlarged plan view showing the sixth pixel PX6 of the display panel PNL of modified example 4. FIG. 34 is an enlarged plan view showing the seventh pixel PX7 of the display panel PNL of modified example 4. Incidentally, in FIG. 33 and FIG. 34, the optical layers OPf and OPg are marked with dot patterns.

As shown in FIG. 32 and FIG. 33, the sixth pixel PX6 comprises a sixth pixel electrode 11f of the plurality of pixel electrodes 11, an optical layer OPf of the plurality of optical layers OP, and an aperture APf of the plurality of apertures AP.

The optical layer OPf faces the sixth pixel electrode 11f. In modified example 4, the optical layer OPf faces a part of the sixth pixel electrode 11f. In addition, the optical layer OPf overlaps with a partial area of the aperture APf. For example, the optical layer OPf overlaps with 75% of the sixth pixel electrode 11f. The optical layer OPf has a width Wopf in the second direction Y. In modified example 4, the width Wopf is smaller than the width Wopa in FIG. 21. In plan view, the size of the optical layer OPa is larger than the size of the optical layer OPg.

As shown in FIG. 32 and FIG. 34, the seventh pixel PX7 comprises a seventh pixel electrode 11g of the plurality of pixel electrodes 11, an optical layer OPg of the plurality of optical layers OP, and an aperture APg of the plurality of apertures AP.

The optical layer OPg faces the seventh pixel electrode 11g. In modified example 4, the optical layer OPg faces several parts of the seventh pixel electrode 11g. In addition, the optical layer OPg overlaps with a partial area of the aperture APg. For example, the optical layer OPg overlaps with 50% of the seventh pixel electrode 11g. The optical layer OPg has a width Wopg in the second direction Y. In modified example 4, the width Wopg is smaller than the width Wopf. In plan view, the size of the optical layer OPg is larger than the size of the optical layer OPf. As shown in FIG. 31, FIG. 33, and FIG. 34,

the optical layers OPf and OPg can cover the entire side surface Sh2 of the metal line ML1. The optical layers OPf and OPg are in contact with each of the portion of the main surface Sf1 of the basement 20, which is on the side surface Sc2 side from the metal line ML1, the side surface Sh2 of the metal line ML1, and the main surface Sg2 of the metal line ML1.

In the sixth pixel PX6, the seventh pixel PX7, and the like, the light emitted from the second light source unit LU2 is more likely to hit the metal line ML1 than the light emitted from the first light source unit LU1. Since the side surface Sh2 faces the side surface Sc2 (i.e., the light emitting element LS of the second light source unit LU2) side, the light emitted from the second light source unit LU2 can easily hit the side surface Sh2. The optical layers OPf and OPg can cover the side surface Sh2. Therefore, scattering (reflection) of light on the side surface Sh2 can be suppressed.

The same advantages as those of the above-described third embodiment can also be obtained in modified example 4. Furthermore, the size of the optical layer OP is smaller as the optical layer OP is farther from the first light source unit LU1 and the second light source unit LU2. When the light is emitted on both sides of the transparent substrate ME1, more light can be made to reach the center of the display area DA of the display panel PNL. Therefore, the reduction in the luminance level in the center of the display device DSP can be suppressed.

### Fourth Embodiment

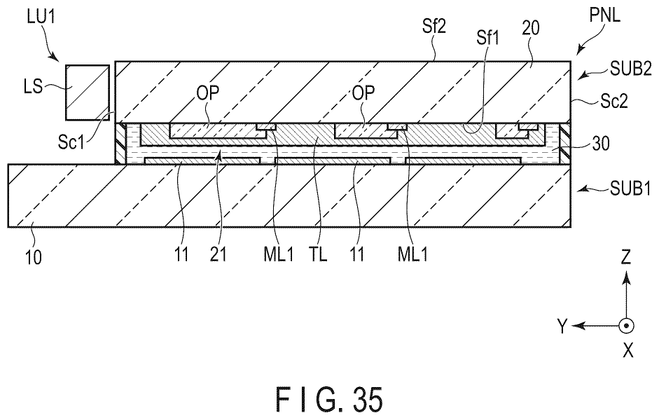

Next, a fourth embodiment will be described. The display device DSP is configured in the same manner as the display device DSP of the first embodiment except for the configuration described in the fourth embodiment. FIG. 35 is a cross-sectional view showing the display device DSP of the fourth embodiment, showing a plurality of metal lines ML1, a plurality of optical layers OP, and the like. Incidentally, in the fourth embodiment, the display device DSP is not curved. FIG. 35 shows only the main parts necessary for the descriptions with respect to the display panel PNL.

As shown in FIG. 35, the display device DSP is formed without the transparent substrate ME1 and the adhesive sheet AD1. The light emitting element LS of the first light source unit LU1 faces only the side surface Sc1 of the basement 20.

In the display device DSP of the fourth embodiment configured as described above as well, the same advantages as those of the first embodiment can be obtained, and the display device DSP capable of improving the display quality can be obtained. Since the display panel PNL does not need to be attached to the transparent substrate ME1, mixture of a foreign matter in the display device DSP can be suppressed or prevented. Incidentally, when the display panel PNL is attached to the transparent substrate ME1, a foreign matter may be mixed between the transparent substrate ME1 and the display panel PNL. If a foreign matter is mixed, scattering of light may occur on the foreign matter and cause bright spots.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the first, second, and third colors are not limited to red, blue, and green colors, respectively. In addition, the light source unit LU may comprise light emitting elements LS of two or less colors or may comprise light emitting elements LS of four or more colors. Alternatively, the light source unit LU may comprise a light emitting element LS of white color. The number of line memories, the number of pieces of the sub-frame data, and the number of sub-frame periods may be increased or reduced in accordance with the number of types (number of colors) of the light emitting elements LS.

A normal mode polymer dispersed liquid crystal may be used as the liquid crystal layer 30. The liquid crystal layer 30 maintains parallelism of the incident light when the applied voltage is high or scatters the incident light when the applied voltage is low.

Each of the basement 10 and the basement 20 of the display panel PNL may be formed of resin. In this case, each of the basement 10 and the basement 20 is desirably formed of an amorphous resin. One of examples of the amorphous resin is a cyclo-olefin polymer (COP). By forming the basement 10 and the basement 20 of amorphous resin, scattering of light inside each of the basement 10 and the basement 20 can be suppressed and the light can be guided desirably.

Incidentally, each of the basement 10 and the basement 20 may be formed of a crystalline resin. One of examples of a crystalline resin is polyethylene terephthalate (PET).

The second substrate SUB2 may further comprise a transparent insulating layer located between the basement 20 and the optical layer OP. The refractive index of the insulating layer is equivalent to that of the basement 20.

Each of the optical layers OP may correspond to two or more pixels PX. For example, one optical layer OP may be provided for four pixels PX located in two consecutive rows and two consecutive columns. Alternatively, one optical layer OP may be provided for nine pixels PX located in three consecutive rows and three consecutive columns.

Instead of the second substrate SUB2, the first substrate SUB1 may comprise the optical layers OP. Alternatively, both the second substrate SUB2 and the first substrate SUB1 may comprise the optical layers OP.

What is claimed is:

1. A display device comprising:
a display panel including a first substrate, a second substrate, and a liquid crystal layer located between the first substrate and the second substrate and containing streaky polymers and liquid crystal molecules,
wherein
the second substrate includes:
a transparent first basement having a first main surface opposed to the liquid crystal layer, a second main surface on a side opposite to the first main surface, and a first side surface located between the first main surface and the second main surface;
a transparent conductive layer located between the first main surface and the liquid crystal layer;
a metal line located between the first main surface and the transparent conductive layer, formed of metal, and being in contact with the transparent conductive layer; and
a first optical layer located between the first main surface and the transparent conductive layer, overlapping with the metal line, and having a refractive index lower than a refractive index of the first basement.

2. The display device of claim 1, wherein
the metal line is in contact with the first main surface,
the first optical layer is located between the metal line and the transparent conductive layer and is in contact with the first main surface and the metal line, and
the transparent conductive layer is in contact with a part of the metal line, which is not in contact with the first basement and the first optical layer.

3. The display device of claim 2, wherein
a thickness of the first optical layer is larger than a thickness of the metal line.

4. The display device of claim 2, further comprising:
a light source unit,
wherein
the display panel includes a display area where images are displayed,
the light source unit is located on the first side surface side with respect to the display area and emits light toward the display area,
the first basement makes light emitted from the light source unit propagate,
the metal line has a third main surface which is in contact with the first main surface, a fourth main surface which is on a side opposite to the third main surface, and a second side surface which is located between the third main surface and the fourth main surface,
the second side surface of the metal line is located on the first side surface side, and
the first optical layer is in contact with each of a portion of the first main surface, which is on the first side surface side with respect to the metal line, the second side surface of the metal line, and the fourth main surface of the metal line.

5. The display device of claim 2, wherein
the metal line includes a first metal layer which is in contact with the first main surface, and a second metal layer which is located on the transparent conductive layer side with respect to the first metal layer and which is stacked on the first metal layer, and
a light reflectance of the first metal layer is higher than a light reflectance of the second metal layer.

6. The display device of claim 1, wherein
the first optical layer is in contact with the first main surface,
the metal line is located between the first optical layer and the transparent conductive layer and is in contact with the first optical layer, and
the transparent conductive layer is in contact with a portion of the metal line, which is not in contact with the first optical layer.

7. The display device of claim 6, wherein
a width of the first optical layer is larger than a width of the metal line.

8. The display device of claim 7, further comprising:
a light source unit,
wherein
the display panel includes a display area where images are displayed,
the light source unit is located on the first side surface side with respect to the display area and emits light toward the display area,
the first basement makes light emitted from the light source unit propagate, and
the width of the first optical layer is larger than the width of the metal line in a direction in which the light source unit emits light.

9. The display device of claim 8, wherein
the first optical layer has a fifth main surface which is in contact with the first main surface, and a sixth main surface which is on a side opposite to the fifth main surface,
the sixth main surface includes a contact area and a non-contact area which is located on the first side surface side with respect to the contact area, and
the metal line is in contact with the contact area of the sixth main surface.

10. The display device of claim 9, wherein
a thickness of the first optical layer is larger than a thickness of the metal line.

11. The display device of claim 6, wherein
the metal line includes a first metal layer which is in contact with the first optical layer, and a second metal layer which is located on the transparent conductive layer side with respect to the first metal layer and which is stacked on the first metal layer, and
a light reflectance of the first metal layer is higher than a light reflectance of the second metal layer.

12. The display device of claim 1, further comprising:
a light source unit,
wherein
the display panel includes a display area where images are displayed, and a first pixel and a second pixel which are located in the display area,
the light source unit is located on the first side surface side with respect to the display area and emits light toward the display area,
the first substrate includes a transparent second basement, a first pixel electrode located between the second basement and the liquid crystal layer, and a second pixel electrode located between the second basement and the liquid crystal layer,
the first pixel electrode is located between the first side surface and the second pixel electrode,
the second substrate includes a second optical layer located between the first main surface and the transparent conductive layer, opposed to the second pixel electrode, and having a refractive index lower than a refractive index of the first basement,
the first optical layer is opposed to the first pixel electrode, and
a size of the first optical layer is larger than a size of the second optical layer in plan view.

13. The display device of claim 1, further comprising:
a transparent substrate having a seventh main surface opposed to the second substrate, an eighth main surface on a side opposite to the seventh main surface, and a third side surface located between the seventh main surface and the eighth main surface;
a fixing member located between the transparent substrate and the display panel to fix the display panel to the transparent substrate; and
a light source unit opposed to the third side surface of the transparent substrate to emit light to the third side surface.

14. The display device of claim 13, wherein
the light source unit is opposed to the first side surface side of the first basement and emits light toward the first side surface.

15. A display device comprising:
a display panel including a first substrate, a second substrate, and a liquid crystal layer located between the first substrate and the second substrate,
wherein
the second substrate includes:
a transparent first basement having a first main surface opposed to the liquid crystal layer, a second main surface on a side opposite to the first main surface, and a first side surface located between the first main surface and the second main surface;
a transparent conductive layer located between the first main surface and the liquid crystal layer;
a metal line located between the first main surface and the transparent conductive layer, formed of metal, and being in contact with the transparent conductive layer; and
a first optical layer located between the first main surface and the transparent conductive layer, overlapping with the metal line, and having a refractive index lower than a refractive index of the first basement, and
an opposite side of the first substrate from the liquid crystal layer is visually recognizable from the second main surface.

16. The display device of claim 15, wherein
the metal line is in contact with the first main surface,
the first optical layer is located between the metal line and the transparent conductive layer and is in contact with the first main surface and the metal line, and
the transparent conductive layer is in contact with a part of the metal line, which is not in contact with the first basement and the first optical layer.

17. The display device of claim 16, wherein
a thickness of the first optical layer is larger than a thickness of the metal line.

18. The display device of claim 15, further comprising:
a transparent substrate having a seventh main surface opposed to the second substrate, an eighth main surface on a side opposite to the seventh main surface, and a third side surface located between the seventh main surface and the eighth main surface;
a fixing member located between the transparent substrate and the display panel to fix the display panel to the transparent substrate; and
a light source unit opposed to the third side surface of the transparent substrate to emit light to the third side surface.

19. The display device of claim 18, wherein
the light source unit is opposed to the first side surface side of the first basement and emits light toward the first side surface.
